(19) United States
(12) Patent Application Publication
(10) Pub. No.: US 2019/0284430 A1
(43) Pub. Date: Sep. 19, 2019

(54) LED CURABLE COATINGS FOR FLOORING COMPRISING DIAMOND PARTICLES AND METHODS FOR MAKING THE SAME

(71) Applicant: AFI Licensing LLC, Lancaster, PA (US)

(72) Inventors: Gary A SIGEL, Columbia, PA (US); Dong TIAN, Lancaster, PA (US); Daniel P. BAKER, Downington, PA (US)

(21) Appl. No.: 16/339,970

(22) PCT Filed: Oct. 4, 2017
(86) PCT No.: PCT/US2017/055060

§ 371 Date: Apr. 5, 2019

Related U.S. Application Data
(60) Provisional application No. 62/404,503, filed on Oct. 5, 2016.

(51) Int. Cl. C09D 133/10; B05D 3/06; C09D 175/16; C09D 183/06; C09D 7/61; C09D 7/40; E04F 15/02; C09D 7/80; C09D 7/63; B05D 7/00

(52) U.S. Cl. CPC C09D 133/10; B05D 3/067; C09D 175/16; C09D 183/06; C09D 7/61; C08K 3/04; E04F 15/02; C09D 7/80; C09D 7/63; B05D 7/546; B05D 2203/30; C09D 7/68

(57) ABSTRACT

A curable coating for a substrate, preferably flooring, that is curable by LED light is disclosed. The curable coating contains: a coating matrix: an LED cure system; and diamond particles. A method of making a coated substrate and making a multi-layer coated substrate are also disclosed. The methods include: applying a first layer of an curable coating that contains diamond particles to the substrate; curing the first layer with an LED light, and optionally also UV light or germicidal lamp; and, in the case of making a multi-layer coated substrate, applying an additional layer of the LED curable coating, which is subsequently cured with an LED light.

### CROSS-REFERENCE TO RELATED APPLICATIONS

This application claim benefit of U.S. Provisional Application No. 62/404,503, filed Oct. 5, 2016, the contents of which are incorporated herein by reference.

### FIELD OF THE INVENTION

The present disclosure is directed to an LED curable coating for a substrate comprising a coating matrix, an LED cure system and diamond particles that provides improved performance, reduced energy emissions and is applicable to temperature sensitive substrates. Also included are methods of making an LED curable coating, as well as methods of making a substrate coated with an LED curable coating, wherein the substrate may be a flooring material.

### BACKGROUND OF THE INVENTION

Coatings containing abrasion resistant particles have been used to cover surfaces of flooring materials and other surfaces to protect such products or surfaces from damage by abrasion or scratch and from tarnish by stain and dirt. Conventional abrasion resistant coatings incorporate aluminum oxide, silicon carbide or silica (see, e.g., WO 2011/037872 and U.S. Pat. No. 6,803,408). Often, the formulations require large amounts of the abrasion resistant particles and yet still provide inadequate protection of the surface from scratch and tarnish.

Other attempts to improve coatings have involved incorporating a harder resin with increased crosslinking. The resulting coatings have improved scratch resistance due to high glass transition temperature (Tg) and crosslinking, but are less flexible and prone to cracking.

There exists a need for better, high-performance coatings to increase scratch resistance and improve wearability and cleanliness of flooring.

Conventional curing techniques have also varied in an attempt to improve properties of the coating and coated flooring. The use of ultraviolet mercury arc lamps emitting ultraviolet (UV) light is well known for curing coatings applied to various substrates. In addition, in limited and specific context, light emitting diode (LED) lamps have been used to cure coatings. LEDs are semiconductor devices which use electroluminescence to generate light. LEDs consist of a semiconducting material doped with impurities to create a p-n junction capable of emitting light as positive holes join with negative electrons when voltage is applied. The wavelength of emitted light is determined by the materials used in the active region of the semiconductor. Typical materials used in semiconductors of LEDs include, for example, elements from Groups 13 (III) and 15 (V) of the periodic table. These semiconductors are referred to as III-V semiconductors and include, for example, GaAs, GaP, GaAsP, AlGaAs, InGaAsP, AlGaInP, and InGaN semiconductors. Other examples of semiconductors used in LEDs include compounds from Group 14 (1V-1V semiconductor) and Group 12-16 (II-VI). The material selection is based on factors including, but not limited to, desired wavelength of emission, performance parameters, and cost.

It is possible to create LEDs that emit light anywhere from wavelengths at about 100 nm to about 900 nm. Presently known LED UV light sources emit light at wavelengths between about 300 nm and about 475 nm. Common peak spectral outputs are 365 nm, 390 nm and 395 nm being common peak spectral outputs.

Specifically, for example, WO 2011/084554 teaches the use of LED to cure coatings on concrete floors using a single 395 nm wavelength array. However, the compositions taught therein do not include diamond particles and are not expected to have stain or wear resistance as high as the coatings disclosed herein.

Others have tries curing with LED in combination with Hg Medium Pressure UV lamps, but not on coatings as disclosed herein.

It is well known that LED lamps offer several advantages over conventional Hg Medium Pressure lamps including: 1) LED lamps turn on and off instantaneously with no warm up time since the light emitting diodes are based on a semiconductor construction that relies on electroluminescence to generate the light vs. conventional arc lamps that require an electric arc to vaporize the Hg inside an inert atmosphere; 2) LED lamps exhibit longer bulb life; and 3) LED lamps consume low amounts of energy in comparison to Mercury vapor lamps. Thus, LED curing offers advantages over traditional curing by Mercury vapor lamps by requiring less power and transferring less heat to the substrate.

Current coatings for floors are not suitable for curing by LED lamps because they have been formulated to be cured by mercury arc lights which produce a different spectral output. While conventionally used UV curable coatings for floors may begin to cure when exposed to light from an LED light source, the curing process would not be commercially successful since the process would be very slow. In addition, the present formulations used in this manner are not formulated for LED curing and thus the properties of the cured final product would not meet performance requirements. It is simply not practical to use LED lamps to cure conventional radiation curable coatings for floors.

Therefore, there is a need to develop LED curable high performance coatings for all flooring, including tile, sheet goods and wood substrates. In addition, formula changes are required to floor coatings that contain diamonds in order for them to be compatible with LED curing technology.

### SUMMARY OF THE INVENTION

The disclosure is directed to an LED curable coating for a substrate containing i) a coating matrix, ii) an LED cure system, and iii) diamond particles. The LED cure system may be selected from a group consisting of photoinitiators, thermal initiators, LED curing resins, and combinations thereof. In an embodiment thereof, the coating matrix is selected from the group consisting of polyester acrylates, aliphatic polyurethane acrylates, silicone acrylates, and combinations thereof, and optionally the diamond particles are encapsulated into a 100% solids coating matrix. In another embodiment thereof, the LED curable coating further comprises at least one additional abrasion resistant particle, a matting agent, and/or other additives. Yet another embodiment thereof includes nano-sized diamond particles, micro-sized diamond particles, or a mixture of nano-sized and micro-sized diamond particles. A ratio of the average thickness of a layer of the coating to the average particle size of the diamond particles may range from about 0.6:1 to about 2:1.

Another embodiment is a flooring product comprising: a substrate; and a scratch resistant layer made from the LED curable coating containing: i) a coating matrix, ii) an LED cure system, and iii) diamond particles.

A still further embodiment is a method of making a coated substrate comprising: applying a first layer of an LED curable coating containing i) a coating matrix, ii) an LED cure system, and iii) diamond particles, to a substrate; and curing the first layer with an LED light to make the coated substrate. In an embodiment thereof, curing may further include irradiating the first layer with a germicidal lamp, an excimer laser, and/or a UV light.

In another embodiment of the disclosure, a method of making a multi-layer coated substrate is disclosed. The method includes: (a) applying a first layer of the LED curable coating of claim 1 to the substrate; (b) curing the first layer with an LED light; (c) applying an additional layer of the LED curable coating to the top surface of the coated substrate; and (d) curing the additional layer with an LED light to make the multi-layer coated substrate. Steps c and d may optionally be repeated two to five times to make the multi-layer coated substrate.

### BRIEF DESCRIPTION OF THE DRAWINGS

FIG. 1 is a photograph showing topcoats being cured in air using LED 385 nm followed by LED 365nm modules.

FIG. 2 is a bar chart of scuff resistance for each formulation LED cured under air and nitrogen.

FIG. 3 are photographs showing the initial scuff damage to Formulation A cured in an air atmosphere versus a nitrogen atmosphere.

FIG. 4 summarizes the impact of formulation and atmosphere (air versus nitrogen) LED cure on percent gloss retained.

FIG. 5 is a photograph showing light scratch damage for formulation C LED when cured under air (left) and nitrogen (right).

FIG. 6 is a photograph showing severe scratch damage to the ‘Control’ formulation when cured using LED/UV under air due to insufficient cure after 8 passes through 385 nm and 365 nm LED arrays.

FIG. 7 is a chart showing the effect of air versus nitrogen cure on initial color, and iodine staining in a beige substrate.

FIG. 8 is a chart showing the effect of air versus nitrogen LED cure on double bond conversion.

FIG. 9 is a chart showing the break elongation % for PVC film and UV coated PVC film.

FIG. 10 is a chart showing the break elongation % for each LED cured coating series.

FIG. 11 is chart showing strain sweep for PVC film, UV cured, LED formulation B, and LED formulation G and measured at 100° C. and 0.1 Hz.

FIG. 12 is a chart showing the effect of LED cure air versus nitrogen on glass transition temperature (T_{g}).

FIG. 13 is a plot of double bond equivalence versus glass transition temperature (Tg) (° C.) for Air versus nitrogen cure.

FIG. 14 is a photograph of Formulation A on solid wood coating structure showing good Gardner Scratch test results.

### DETAILED DESCRIPTION OF THE INVENTION

The present disclosure overcomes the problems known in the art some of which are identified above. In particular, a coating containing diamond particles is disclosed that may be cured using LED (light-emitting diode) curing technology in the factory or on site. This advancement reduces wasted energy, emissions, and allows application of the coating to temperature sensitive substrates, while offering superior wear performance. The present disclosure optionally incorporates a combination of LED arrays, or mixtures, with UV light, and/or LED germicidal technology providing a process to cure high performance diamond containing coatings that have surface properties comparable to or better than UV cured coatings.

LED Curable Coating

An embodiment is directed to an LED curable coating for a substrate comprising: a coating matrix; an LED cure system; and diamond particles.

An LED curable coating is capable of curing by irradiating with light emitted from a light emitting diode (LED) light, optionally at multiple varying wavelengths or in combination with other light sources.

In an embodiment, the coating matrix of the present disclosure contains acrylate-functional monomers and acrylate-functional oligomers, that includes mono-functional oligomers, di-functional oligomers, tri-functional oligomers, tetra-functional oligomers, penta-functional oligomers, and combinations thereof, as defined in co-pending U.S Patent Application Publication No. 2016/0289980 (U.S. application Ser. No. 14/678,163; entitled SCRATCH RESISTANT COATING). The entire disclosure of this co-pending application is incorporated by reference herein.

Preferably, the coating matrix of the present disclosure contains acrylate-functional oligomers including, but not limited to, polyester acrylates, silicone acrylates, aliphatic polyurethane acrylates, and combinations thereof. Commercial examples of these acrylates may include, but are not limited to, EC6360, EB8602, SR833S, SR 351, SR506A, Ebecry 114, SR 238, and Scls UV RCA170.

The polyester acrylate used according to the present disclosure may be a linear or branched polymer having at least one acrylate or (meth)acrylate functional group. In some embodiments, the polyester acrylate has at least 1 to 10 free acrylate groups, (meth)acrylate groups, or a combination thereof. In certain embodiments, the polyester acrylate has an acrylate functionality. The polyester acrylate may be the reaction product of polyester polyol and an carboxylic acid functional acrylate compound such as acrylic acid, (meth)acrylic acid, or a combination thereof at a OH:COOH ratio of about 1:1. The polyester polyol may be a polyester diol having two hydroxyl groups present at terminal end of the polyester chain. In some embodiments, the polyester polyol may have a hydroxyl functionality ranging from 3 to 9, wherein the free hydroxyl groups are present at the terminal ends of the polyester chain or along the backbone of the polyester chain.

In non-limiting embodiments, the polyester polyol may be the reaction product of a hydroxyl-functional compound and a carboxylic acid functional compound. The hydroxyl-functional compound is present in a stoichiometric excess to the carboxylic-acid compound. In some embodiments, the hydroxyl-functional compound is a polyol, such a diol or a tri-functional or higher polyol (e.g. triol, tetrol, etc.). The polyol may be aromatic, cycloaliphatic, aliphatic, or a combination thereof. In some embodiments, the carboxylic acid-functional compound is dicarboxylic acid, a polycarboxylic acid, or a combination thereof. In some embodiments, the dicarboxylic acid and polycarboxylic acid may be aliphatic, cycloaliphatic, aromatic, or a combination thereof.

In certain embodiments, the diol may be selected from alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; cyclohexanedimethanol; hexanediols including 1,6-hexanediol; caprolactonediol (for example, the reaction product of epsilon-caprolactone and ethylene glycol); hydroxy-alkylated bisphenols; polyether glycols, for example, poly(oxytetramethylene) glycol. In some embodiments, the tri-functional or higher polyol may be selected from trimethylol propane, pentaerythritol, di-pentaerythritol, trimethylol ethane, trimethylol butane, dimethylol cyclohexane, glycerol and the like.

In some embodiments, the dicarboxylic acid may be selected from adipic acid, azelaic acid, sebacic acid, succinic acid, glutaric acid, decanoic diacid, dodecanoic diacid, phthalic acid, isophthalic acid, 5-tert-butylisophthalic acid, tetrahydrophthalic acid, terephthalic acid, hexahydrophthalic acid, methylhexahydrophthalic acid, dimethyl terephthalate, 2,5-furandicarboxylic acid, 2,3-furandicarboxylic acid, 2,4-furandicarboxylic acid, 3,4-furandicarboxylic acid, 2,3,5-furantricarboxylic acid, 2,3,4,5-furantetracarboxylic acid, cyclohexane dicarboxylic acid, chlorendic anhydride, 1,3-cyclohexane dicarboxylic acid, 1,4-cyclohexane dicarboxylic acid, and anhydrides thereof, and mixtures thereof. In some embodiments, the polycarboxylic acid may be selected from trimellitic acid and anhydrides thereof.

Any silicone acrylate known for use in the art may be used in accordance with the present disclosure, for example in U.S. Pat. No. 4,528,081 and U.S. Pat. No. 4,348,454. Suitable silicone acrylates include silicone acrylates having mono-, di-, and tri-acrylate moieties. Suitable silicone acrylates include, for example, Silcolease® UV RCA 170 and UV Poly 110, available from Blue Star Co. Ltd, China; and Silmer ACR D2, Silmer ACR Di-10, Silmer ACR Di-50 and Silmer ACR Di-100, available from Siltech.

Any aliphatic polyurethane acrylate known for use in the art may be used in accordance with the present disclosure.

The curable coating may comprise about 65 wt. % to about 95 wt. % of the coating matrix relative to the total weight of the coating. In another embodiment, the curable coating may comprise about 75 wt. % to about 95 wt. %, preferably about 77 wt. % to about 93 wt. %, of the curable coating matrix relative to the total weight of the curable coating.

Diamond Particles

The LED curable coating disclosed herein includes diamond particles, which are abrasion resistant and impart wear and scratch resistance to the overall coating. The improved wear and scratch resistance extends the life span of the floor covering. The diamond particles used in accordance with the present disclosure are preferably made from synthetic diamonds, though natural diamonds may also be used. To make the diamond particles, diamonds are ground to a desired size, preferably, having a narrow particle size distribution. The term “narrow particle size distribution” as used herein means a standard deviation that is no more than about 35%, preferably less than 35%, more preferably less than about 25%, and still more preferably less than about 15% deviation based on the average particle size for any given diamond particle in a blend or mixture.

In certain embodiments of the invention, the diamond particles are nano-sized. Nano-sized diamond particles may have an average particle size of about 1.0 nanometers (nm) to about 900 nm, preferably about 1.5 nm to about 600 nm, and more preferably about 2.0 nm to about 500 nm. In other embodiments of the invention, the diamond particles are micro-sized. The micro-sized diamond particles may have an average particle size of about 0.2 μm to about 200 μm, preferably about 0.5 μm to about 100 μm, and more preferably about 1 μm to about 50 μm. In a preferred embodiment, the diamond particles are a mixture of nano-sized diamond particles and micro-sized diamond particles. The mixture of sizes results in improved scratch resistance because the nano-sized diamond particles intercalate between larger sized micro-sized particles.

The curable coating may comprise diamond particles in an amount that ranges from about 0.5 wt. % to less than 5.5 wt. %, based on the total weight of the curable coating, preferably about 1 wt. % to about 5 wt. %, and more preferably, about 2 wt. % to about 4.5 wt. %. In an embodiment, the curable coating comprises about 2.5 wt. % to about 4 wt. % of diamond particles. It has been discovered that after application on a substrate and curing a coating that incorporates diamond particles in the above recited amounts, the coated substrate exhibits improved, desired scratch resistance and gloss retention properties. It has also been found that exceeding diamond particle loading amounts of 5.5 wt. %, may result in undesirable effects to the visual properties of the wear layer.

In an embodiment, it is desirable that the color Δb value remain as low as possible because higher Δb values result in a coating having a yellow appearance. Therefore, it has been discovered that at diamond particle loading amounts ranging between 2 wt. % and under 6 wt. %—preferably under 5.5 wt. %—the resulting coating not only exhibits desirable abrasion resistance and gloss retention properties, but also will not exhibit a color Δb value that interferes with the desired aesthetic appearance of the coating.

Delta b (Δb) or difference in b values between a control and a sample indicates the degree of yellowing. The degree of yellowing is measured by use of a calorimeter that measures tristimulas color values of ‘a’, ‘b’, and ‘L’, where the color coordinates are designated as +a (red), −a (green), +b (yellow), −b (blue), +L (white), and −L (black).

According to some embodiments, a ratio of the average coating matrix thickness to average particle size of the diamond particles ranges from about 0.6:1 to about 2:1, preferably from about 0.8:1 to about 2:1, more preferably from about 0.9:1 to about 1.5:1, and most preferably, about 1:1.

In some embodiments, the diamond particles have an average distance between two adjacently placed particles from about 20 μm to about 75 μm, and preferably from about 30 μm to about 65 μm, which is measured between the centers of the adjacent diamond particles.

Upon mixing the diamond particles with the coating matrix, the diamond particles are believed to be encapsulated into a 100% solids coating matrix.

LED Cure System

An LED cure system in accordance with the disclosure may be a photoinitiator, a thermal initiator, an LED curing resin, or any combination thereof that is capable of curing by irradiating with a light emitting diode (LED) light. In certain embodiments, the cure system is capable of curing by irradiating with light emitted from an LED light, optionally at more than one wavelength, or in combination with a UV light, a germicidal lamp, and/or excimer laser.

The LED light may come from any known LED light source (e.g., LED lamp) and has a wavelength from about 100 nm to about 900 nm. In other embodiments, the LED light has a wavelength of about 100 nm to about 300 nm, about 300 nm to about 475 nm, or about 475 nm to about 900 nm. Any conventionally known UV light from any known light source may be used in accordance with the invention.

In an embodiment, two or more LED lights may be used with each supplying the same or a different wavelength. In an embodiment thereof, a first LED light having a wavelength of about 300 nm to about 475 nm, and a second LED light having a wavelength of about 300 nm to about 475 nm may be used to cure the curable coating. In a further embodiment thereof, a first LED light having a wavelength of about 350 nm to about 400 nm, preferably about 370 nm to about 400 nm, and a second LED light having a wavelength of about 350 nm to about 400 nm, preferably about 350 nm to about 370 nm, is used, wherein the wavelength of the first LED light is different from the wavelength of the second LED light.

A germicidal lamp produces short-wave ultraviolet light that disrupts DNA base pairing causing pyrimidine dimers formation and leads to the inactivation of bacteria, viruses, and protozoa. Germicidal lamps provide UVA output between 100 nm to 280 nm that is particularly useful for surface cure of UV coating systems due to the short wavelength in combination with UV photoinitatiors that absorb strongly in this wavelength. By utilizing germicidal lamps under an atmosphere of nitrogen less than about 1000 ppm, preferably less than about 100 ppm, or more preferably less than about 50 ppm, to prevent oxygen inhibition, the surface cure has been found to give exceptional stain and wear resistance when combined with LED cure. In a certain embodiment, the germicidal lamp emits light having a wavelength of about 105 nm to about 200 nm, and preferably about 110 nm to about 150 nm.

Any excimer laser known in the art may be used in accordance with the disclosure. Excimer lasers have extremely high ouput and may be useful for surface cure of UV coatings to enhance surface cure characteristics. The high output at the surface results in high crosslinking.

In a certain embodiment, the excimer laser emits light having a wavelength of about 120 nm to about 360 nm, preferably about 120 nm to about 280 nm, and more preferably about 170 nm to about 180 nm. In an embodiment, the excimer laser is used as the source of high-energy photons. One can use, for example, an xenon or argon lamp. As a possible inert gas, one can use argon, nitrogen, or a mixture thereof, preferably nitrogen. The excimer laser to be used is not limited to the aforementioned xenon or argon lamps and can be adapted in its wavelength to the type of surface configuration desired.

Any photoinitiator known in the art may be used in accordance with the invention. In one embodiment, the photoinitiator may be a benzoin compound, an acetophenone compound, an acylphosphine oxide compound, a titanocene compound, a thioxanthone compound or a peroxide compound, or a photosensitizer such as an amine or a quinone. Specific examples of photoinitiatiors include 1-hydroxycyclohexyl phenyl ketone, benzoin, benzoin methyl ether, benzoin ethyl ether, benzoin isopropyl ether, benzyl diphenyl sulfide, tetramethylthiuram monosulfide, azobisisobutyronitrile, dibenzyl, diacetyl and beta-chloroanthraquinone. In some embodiments, the photoinitators are water soluble alkylphenone photoinitiators.

In another embodiment, the photoinitiator may be selected from the group consisting of: 2-benzyl-2-(dimethylamino)-4 ′-morpholinobutyrophenone, bis(2,4,6-trimethylbenzoyl)-phenylphosphineoxide, 2,4,6-trimethylbenzoyl diphenylphosphineoxide, 2-methyl-4′-(methylthio)-2-morpholinopropiophenone, 4-benzoyl-4′-methyl-diphenylsulfide, 2-isopropyl thioxanthone, and any combination thereof.

In another embodiment, the photoinitiator may be selected from the group consisting of: benzoylphosphine oxides, such as, for example, 2,4,6-trimethylbenzoyl diphenylphosphine oxide (Lucirin TPO from BASF) and 2,4,6-trimethylbenzoyl phenyl, ethoxy phosphine oxide (Lucirin TPO-L from BASF), bis(2,4,6-trimethylbenzoyl)-phenylphosphineoxide (Irgacure 819 or BAPO from Ciba), 2-methyl-1-[4-(meth.ylthio)phenyl]-2-morphoiinopropanone-1 (Irgacure 907 from Ciba), 2-benzyl-2-(dimethylamino)-1-[4-(4-morpholinyl) phenyl]-1-butanone (Irgacure 369 from Ciba), 2-dimethylamino-2-(4-methyl-benzyl)-1-(4-morpholin-4-yl-phenyl)-butan-1-one (Irgacure 379 from. Ciba), 4-benzoy 1-4′-methyl diphenyl sulphide (Chivacure BMS from Chitec), 4,4′-bis(diethylamino) benzophenone (Chivacure EMK from Chitec), and 4,4′-bis(N,N′-dimethylamino) benzophenone (Michler's ketone), 4-methyl benzophenone, 2,4,6-trimethyl benzophenone, and dimethoxybenzophenone, and, 1-hydroxyphenyl ketones, such as 1-hydroxycyclohexyl phenyl ketone, phenyl (1-hydroxyisopropyl)ketone, 2-hydroxy-1-[4-(2-hroxyethoxy) phenyl]-2-methyl-1-propanone, and 4-isopropylphenyl(1-hydroxy isopropyl)ketone, benzil dimethyl ketal, and oligo-[2-hydroxy-2-methyl˜-1-[4-(1-methylvinyl)phenyl] propanone] (Esacure KIP 150 from Lamberti), camphorquinone, 4,4′-bis(diethylamino) benzophenone (Chivacure EMK from Chitec), 4,4′-bis(N,N′-dimethylamino) benzophenone (Michler's ketone), bis(2,4,6-trimemylbenzoyl)-phenylphosphineoxide (Irgacure 819 or BAPO from Ciba), metallocenes such as bis (eta 5-2-4-cyclope.ntadien-1-yl) bis [2,6-difluoro-3-(1H-pyrrol-1-yl) phenyl] titanium (Irgacure 784 from Ciba).

In a certain embodiment, the photoinitator may be selected from the group consisting of benzoylphosphine oxides, 2-isopropyl thioxanthone, bis(2,4,6-trimethylbenzoyl)-phenylphosphineoxide, 2-methyl-1-[4-(meth.ylthio)phenyl]-2-morphoiinopropanone-1 (, 2-benzyl-2-(dimethylamino)-1-[4-(4-morpholinyl) phenyl]-1-butanone, 2-dimethylamino-2-(4-methyl-benzyl)-1-(4-morpholin-4-yl-phenyl)-butan-1-one, 4-benzoy 1-4′-methyl diphenyl sulphide, 4,4′-bis(diethylamino) benzophenone (, and 4,4′-bis(N,N′-dimethylamino) benzophenone, 4-methyl benzophenone, 2,4,6-trimethyl benzophenone, and dimethoxybenzophenone, and, 1-hydroxyphenyl ketones, benzil dimethyl ketal, and oligo-[2-hydroxy-2-methyl˜1-[4-(1-methylvinyl)phenyl] propanone], camphorquinone, 4,4′-bis(diethylamino) benzophenone, 4,4′-bis(N,N′-dimethylamino) benzophenone, bis(2,4,6-trimemylbenzoyl)-phenylphosphineoxide, and any combination thereof. In an embodiment thereof, the photoinitator may be selected from the group consisting of bis(2,4,6-trimemylbenzoyl)-phenylphosphineoxide (Irgacure 819 or BAPO from Ciba), 2,4,6-trimethylbenzoyl diphenylphosphine oxide (Lucirin TPO from BASF), Benzophenone, 1-Hydroxycyclohexyl phenyl ketone (Irgacure 184), and 2-isopropyl thioxanthone (e.g., ITX-isopropyl thioxanthone), and any combination thereof.

Any thermal initiator known in the art may be used in accordance with the invention. In one embodiment, the thermal initiator is a free radical initiator that generates radicals upon exposure to heat rather than light. In an embodiment, the thermal initiator is selected from a peroxide compound, an azo compound, and a combination thereof. In some embodiments, suitable peroxide and azo initiators include: diacyl peroxides, such as 2-4-diclorobenzyl peroxide, diisononanoyl peroxide, decanoyl peroxide, lauroyl peroxide, succinic acid peroxide, acetyl peroxide, benzoyl peroxide, and diisobutyryl peroxide; acetyl alkylsulfonyl peroxides, such as acetyl cyclohexylsulfonyl peroxide; dialkyl peroxydicarbonates, such as di(n-propyl)peroxy dicarbonate, di(sec-butyl)peroxy dicarbonate, di(2-ethylhexyl)peroxy dicarbonate, diisopropylperoxy dicarbonate, and dicyclohexylperoxy dicarbonate; peroxy esters, such as alpha-cumylperoxy neodecanoate, alpha-cumylperoxy pivalate, t-amyl neodecanoate, t-amylperoxy neodecanoate, t-butylperoxy neodecanoate, t-amylperoxy pivalate, t-butylperoxy pivalate, 2,5-dimethyl-2,5-di(2-ethylhexanoylperoxy)hexane, t-amylperoxy-2-ethyl hexanoate, t-butylperoxy-2-ethyl hexanoate, and t-butylperoxy isobutyrate; and azobis (alkyl nitrile) peroxy compounds, such as 2,2′-azobis-(2,4-dimethylvaleronitrile), azobisisobutyronitrile, azobisisoheptanonitrile, azobisisopentanonitrile, and 2,2′-azobis-(2-methylbutyronitrile); t-butyl-peroxymaleic acid, 1,1′-azobis-(1-cyclohexanecarbonitrile).

In some embodiments, the thermal initiator comprises 2,2′-azobis-(2,4-dimethylvaleronitrile). In another embodiment, the thermal initiator comprises a peroxy ketal, such as 1,1-di(t-butylperoxy)-3,3,5-trimethylcyclohexane; a peroxy ester, such as o,o′-t-butyl-o-isopropyl monoperoxy carbonate, 2,5-dimethyl-2,5-di(benzoylperoxy) carbonate, o,o′-t-butyl-o-(2-ethylhexyl)-monoperoxy carbonate, t-butylperoxy acetate, t-butylperoxy benzoate, di-t-butyldiperoxy azelate, and di-t-butyldiperoxy phthalate; a dialkylperoxide, such as dicumyl peroxide, 2,5-dimethyl-2,5-di(t-butylperoxy)hexane, t-butyl cumyl peroxide, di-t-butyl peroxide, and 2,5-dimethyl,2,5-di(t-butylperoxy)hexyne-3; a hydroperoxide, such as 2,5-dihydroperoxy-2,5-dimethyl hexane, cumene hydroperoxide, t-butyl hydroperoxide and t-amyl hydroperoxide; a ketone peroxide, such as n-butyl-4,4-bis-(t-butylperoxy)valerate, 1,1-di(t-butylperoxy)-3,3,5-trimethyl cyclohexane, 1,1′-di-t-amyl-peroxy cyclohexane, 2,2-di(t-butylperoxy) butane, ethyl-3,3-di(t-butylperoxy)butyrate, or a blend of t-butyl peroctoate, and 1,1-di(t-butylperoxy)cyclohexane.

Any LED curing resin known in the art may be used in accordance with the invention. In one embodiment, the LED curing resin may be selected from the group consisting of: mercapto-modified polyester acrylate resins, mercapto-modified urethane acrylate resins, mercapto-modified epoxy acrylate resins, Tritol (trimethylopropane trithiol), and any combination thereof. In an embodiment thereof, the LED curing resin is a mercapto-modified polyester acrylate resin (such as but not limited to Ebecryl LED 01, Ebecryl LED 02).

In an embodiment, the cure system further comprises a 3M radical initiator available under the Trade Name Vazo that includes, but is not limited to, Vazo 52 2,2′-Azobis(2,4-dimethylvaleronitrile), Vazo 64 2,2′azobis-(2-isobutyronitrile), Vazo 67 Butanenitrile, and 2,2′-azobis(2-methyl). A 3M radical initiator may be added to improve the degree of cure of LED cure systems that could be highly filled or pigmented.

The curable coating may comprise about 70 wt. % to about 95 wt. % of the LED cure system relative to the total weight of the curable coating. In another embodiment, the curable coating may comprise about 75 wt. % to about 92 wt. %, preferably 77 wt. % to about 92 wt. %, of the LED cure system relative to the total weight of the curable coating.

In an embodiment, each fully cured layer of the curable coating has an average coating thickness that ranges from about 2 μm to about 50 μm, preferably about 4 μm to about 40 μm, and more preferably about 6 μm to about 20 μm.

The substrate to which a curable coating of the present disclosure is applied may be any surface used in residential or commercial building. Preferably, it may be selected from any flooring material known in the art, and more preferably from linoleum tile, ceramic tile, natural wood planks, engineered wood planks, vinyl tile—such as luxury vinyl tile (“LVT”), and resilient sheet—such as homogenous or heterogeneous commercial resilient sheets and residential resilient sheets. Because of the LED curing technology used in the present disclosure, the curable coatings disclosed herein may be applied to temperature sensitive substrates, which heretofore could not be used with scratch resistant coatings because of the high temperatures required for UV curing. Such temperature sensitive substrates, include, but are not limited to, rigid films such as PVC, PET, PETG, or tile structures comprised of tile base compositions of 80-90% filler and 10-20% polymeric binder in which a decorative film(s) are laminated to the surface containing PVC, PET, PETG, or PP.

Additives

In certain embodiments of the invention, the curable coating may include an additional abrasion resistant particle having a Mohs value of less than 10. One or more additional abrasion resistant particles may be added, preferably with each exhibiting a Mohs hardness value ranging from 6 to 10—including all integers therebetween, as measured on the Mohs scale of mineral hardness. In some embodiments, the abrasion resistant particles may be selected from aluminum oxide (Mohs value of 9), topaz (Mohs value of 8), quartz (Mohs value of 7), nepheline syenite or feldspar (Mohs value of 6), ceramic or ceramic microspheres (Mohs value of 6), and combinations thereof. Diamond has a Mohs value of 10.

According to some embodiments, the additional abrasion resistant particle may be present relative to the diamond particle in a weight ratio ranging from about 1:1 to about 10:1. In some non-limiting embodiments, the additional abrasion resistant particle is present relative to the diamond particle in a weight ratio of about 1:1. In some non-limiting embodiments, the additional abrasion resistant particle is present relative to the diamond particle in a weight ratio of about 2:1. In some non-limiting embodiments, the additional abrasion resistant particle is present relative to the diamond particle in a weight ratio of about 4:1. In some non-limiting embodiments, the additional abrasion resistant particle is present relative to the diamond particle in a weight ratio of about 8:1. It has been found that coating layers comprising a mixture of diamond particles and additional abrasion resistant particle (e.g., aluminum oxide particles) of the present disclosure exhibit similar abrasion resistance at much lower overall loading levels of abrasion resistant particles compared to coating layers comprising abrasion resistant particles of only aluminum oxide.

In some embodiments, the curable coating of the present disclosure may comprise an amount of abrasion resistant particle (diamond plus an additional abrasion particle) ranging from about 6 wt. % to about 25 wt. % based on the total weight of the curable coating. In some embodiments, the curable coating may comprise an amount of abrasion resistant particle ranging from about 6 wt. % to about 12 wt. % based on the total weight of the curable coating.

According to some embodiments, the additional abrasion resistant particle is aluminum oxide. The aluminum oxide particles may have a variety of particle sizes. In an embodiment, the aluminum oxide particles have an average particle size that is selected from the range of about 2 μm to about 30 μm, preferably in combination with diamond particles having an average particle size that of about 6 μm about 25 μm.

In some embodiments, a mixture of aluminum oxide powder¹ may be selected that has particle sizes at 50% size distribution: ¹ Commercially available Microgrit WCA aluminum oxide powder

| Sample | Size (μm) at 50% |
|---|---|
| 1 | 1.77-2.25 |
| 2 | 2.09-2.77 |
| 3 | 2.97-3.85 |
| 4 | 3.72-4.74 |
| 5 | 5.6-6.75 |
| 6 | 7.05-8.5 |
| 7 | 9.06-11.13 |
| 8 | 12.4-14.66 |
| 9 | 16.92-20.6 |
| 10 | 23.6-27.45 |

In some embodiments, a mixture of aluminum oxide powder² may be selected that has particle sizes at 50% size distribution: ² Commercially available Fujimi PWA aluminum oxide powder

| Sample | Size (μm) at 50% |
|---|---|
| 11 | 3.1 ± 0.3 |
| 12 | 4.7 ± 0.4 |
| 13 | 6.4 ± 0.5 |
| 14 | 8.2 ± 0.6 |
| 15 | 10.2 ± 0.8 |
| 16 | 14.2 ± 1.1 |
| 17 | 17.4 ± 1.3 |
| 18 | 20.8 ± 1.5 |
| 19 | 25.5 ± 1.7 |
| 20 | 29.7 ± 20 |

In some embodiments, the additional abrasion resistant particle is feldspar particles. The feldspar particle may be present relative to the diamond particle in a weight ratio ranging from about 2:1 to about 5:1, and preferably about 4:1. In an embodiment, the feldspar particles may have an average particle size that is selected from the range of about 2 μm to about 30 μm—including all integers therebetween. It has been found that coating layers comprising a mixture of diamond particles and feldspar particles may exhibit similar abrasion resistance at much lower overall loading levels of abrasion resistant particles compared to coating layers comprising abrasion resistant particles of only feldspar.

In an embodiment, the curable coating comprises a matting agent. The matting agent may be any matting agent known for use in the art. Preferably, it may comprise polyamide powder, fluoropolymer, silica, and combinations thereof. In some non-limiting embodiments, the polyamide powder may have a melting point up to 142° C. and a particle size ranging from about 8 μm to 12 μm; preferably 10 μm. The polyamide powder may be polyamide-6,6, polyamide-6,9; polyamide-6,10; polyamide-6,12; and polyamide-12;6/12. Preferably, the polyamide powder may be polyamide-6,12. In some embodiments, the polyamide powder may be present in an amount ranging from about 5 wt. % to about 10 wt. % based on the total weight of the coating layer, and preferably about 6 wt. % to about 8 wt. %.

In some embodiments, the curable coating may further comprise an amine synergist. In an embodiment, the amine synergist may include diethylaminoethyle methacrylate, dimethylaminoethyl methacrylate, N-N-bis(2-hydroxyethyl)-P-toluidine, Ethyl-4-dimethylamino benzoate, 2-Ethylhexyl 4-dimethylamino benzoate, as well as commercially available amine synergist, including Sartomer CN 371, CN373, CN383, CN384 and CN386; Allnex Ebecry P104 and Ebecry P115. The amine synergist may be present in the coating in an amount ranging from about 1 wt. % to about 5 wt. %, preferably about 3 wt. %

In some embodiments, the curable coating may further comprise other additives and fillers, such as abrasives, surfactant, as pigments, tackifiers, surfactants, fluoro-containing compounds, fillers such as glass or polymeric bubbles or beads (which may be expanded or unexpanded), hydrophobic or hydrophilic silica, calcium carbonate, glass or synthetic fibers, blowing agents, toughening agents, reinforcing agents, fire retardants, antioxidants, and stabilizers. The additives are added in amounts sufficient to obtain the desired end properties. Suitable surfactants include, but are not limited to, fluorinated alkyl esters, polyether modified polydimethylsiloxanes and fluorosurfactants, having the formula R_{f}CH₂CH₂O(CH₂CH₂O)ₓH, wherein R_{f}═F(CF₂CF₂)_{y}, x=0 to about 15, and y=1 to about 7. The surfactant may be present in coating in an amount ranging from about 0.5 wt. % to about 2 wt. %, preferably about 0.8 wt. %.

In some embodiments, the fluoro-containing compound, which may also function as a matting agent, is selected from fluoropolymer particles or powders, which are also referred to as fluoropolymer waxes, and mixtures of fluoropolymer waxes and polyolefin waxes, and mixtures thereof. Suitable fluoropolymer waxes may have an average particle size ranging from about 0.5 μm to 30 μm, preferably from about 1 μm to 15 μm. The fluoropolymer waxes may be selected from polytetrafluoroethylene (PTFE), florinated ethylene propylene (FEP), perfluoroalkoxy polymer resin (PFA), ethylene tetrafluoroethylene (ETFE), ethylene chloro trifluoroethylene (ECTFE), polychlorotrifluoroethylene (PCTFE), polyvinylidene fluoride (PVDF), and combinations thereof. In some embodiments, the fluoropolymer is PTFE. Suitable polyolefin waxes include polyethylene waxes and polypropylene waxes. Suitable fluoropolymer mixtures may include between 10 and 90 weight % of a fluoropolymer wax and between 10 and 90 weight % of a polyolefin wax. In some embodiments, the fluoropolymer mixture has between 20 and 30 weight % of a fluoropolymer wax and between 70 and 80 weight % of a polyolefin wax. In some embodiments, the fluoro-containing compound may be present in an amount ranging from about 1 wt. % to 5 wt. % based on the total weight of the coating. In some embodiments, the fluoro-containing compound may be present in an amount ranging from about 1 wt. % to 3.5 wt. % based on the total weight of the coating layer.

A dispersing agent may optionally be added to the coating. The dispersing agent may be selected from acrylic block-copolymers, such as commercially available BYK Disperbyk 2008, Disperbyk 2155, Disperbyk 145 and Disperbyk 185, Lubrizol Solsperse 41000 and Solsperse 71000, and may be present in the coating layer by an amount ranging from 0.1 wt. % to 1 wt. %.

Flooring Product

Another embodiment of the invention is a flooring product comprising: a substrate and a scratch resistant layer made from an LED curable coating. The LED curable coating for use in this embodiment of the disclosure is the same as that described above. Likewise, the terms used in connection with this embodiment have the same meanings as defined in the embodiments above.

The flooring product may optionally further comprise a print layer between the substrate and the scratch resistant layer. The flooring product may optionally further comprise a top coat layered on the top surface of the scratch resistant layer. In an embodiment, the flooring product may comprise the print layer and the top coat.

The flooring product may be any product sold for use in residential or commercial flooring.

Any print layer known for use in the art may be used with the present disclosure. Any top coat known for use in the art may be used with the present disclosure, for example, but not limited to waxes, epoxy, shellac, polyurethanes, and glosses.

Methods of Use

Another embodiment is directed to a method of making a coated substrate comprising the steps of: applying a first layer of an LED curable coating to the substrate; and curing the first layer with an LED light to make the coated substrate. The LED curable coating for use in this embodiment of the disclosure is the same as that described above. Likewise, the terms used in connection with this embodiment have the same meanings as defined in the embodiments above. The first layer of the LED curable coating is applied to a substrate by any suitable coating method known in the art, including roll coating.

In an embodiment thereof, the step of curing may comprise: i) irradiating with a first LED light having a first wavelength; and ii) irradiating with a second LED light having a wavelength different from the first. Preferably, the first wavelength might be about 370 nm to about 395 nm, and more preferably about 380 nm to about 390 nm. Preferably, the second wavelength might be about 350 nm to about 380 nm, and more preferably about 360 nm to about 370 nm.

In an embodiment, the step of curing may also comprise irradiating with a UV light, a germicidal lamp, an excimer laser, or a combination thereof. Curing by irradiating with a UV light, a germicidal lamp and/or an excimer laser may occur concurrent with, prior to, or subsequent to irradiating with an LED light. In a preferred embodiment, the step of curing may comprise: i) irradiating with a first LED light having a first wavelength; ii) irradiating with a second LED light having a wavelength different from the first; and iii) irradiating with a UV light or a germicidal lamp. The resulting coating may have improved scratch, stain and scuff resistance over conventional coatings that do not incorporate diamond particles therein.

In an embodiment, the step of curing may comprise: i) first, irradiating with a UV light; ii) followed by irradiating with a first LED light having a first wavelength of about 370 nm to about 395 nm; ii) followed by irradiating with a germicidal lamp. In another embodiment, the step of curing may comprise: i) first, irradiating with a UV light; ii) followed by irradiating with a first LED light having a first wavelength of about 370 nm to about 395 nm; and ii) irradiating with a second LED light having a wavelength different from the first of about 350 nm to about 380 nm. In a still further embodiment, the step of curing may comprise: i) first, irradiating with a UV light; ii) followed by irradiating with a LED light having a first wavelength of about 370 nm to about 395 nm; and iii) irradiating with a UV light which may be the same or different from the UV light used in the first step.

In some embodiments, each fully cured coating layer may have an average coating thickness that ranges from about 2 μm to about 50 μm. In some embodiments, the fully cured coating layer may have an average coating thickness that ranges from about 4 μm to about 40 μm. According to an embodiment, the fully cured first layer has an average matrix coating thickness from about 6 μm to about 20 μm, and more preferably, between about 9 μm to about 12 μm.

Yet another embodiment is a method of making a multi-layer coated substrate. In a first step, a first layer of an LED curable coating is applied to a substrate by any suitable coating method known in the art, including roll coating. The first layer may be applied such that the coating exhibits a first average coating thickness. The LED curable coating for use in this embodiment of the disclosure is the same as that described above. Likewise, the terms used in connection with this embodiment have the same meanings as defined in the embodiments above.

In a next step, the first layer may then be partially or fully cured by irradiating with an LED light. Subsequently, an additional layer of the coating may be applied to the top surface of the first layer by any suitable method known in the art, for example, by roll coating, thereby forming a multi-layer coated substrate. The additional layer may be applied such that the coating exhibits a second average coating matrix thickness, which may be the same or different from the first average coating thickness. The additional layer may then be partially or fully cured by irradiating with an LED light.

One or more additional coating layers may be further applied by repeating the steps of applying an additional layer of the LED curable coating on to the top surface of the prior layer, and partially or fully irradiating with an LED light. These steps may be repeated 2 to 5 times. Once the multi-layer coated substrate is formed, the multi-layer coated substrate may be fully cured, if any of the previously applied layers has only been partially cured. The term partial curing as used herein refers to curing a coated layer to a nonfluid state (i.e., semi-solid or solid) that may be tacky to the touch.

The LED curable coating can be partially cured in some embodiments to prevent the abrasion resistant particles from fully settling within the coating. In some embodiments, the substrate may be coated with two, three or more layers of the curable coating, each additional layer positioned on top of the previously applied layer. According to this embodiment, each layer may each be partially or fully cured before application of a subsequent layer of the coating to prevent the diamond particles of each layer of coating from fully settling.

In an embodiment thereof, one or more curing steps may comprise: i) irradiating with a first LED light having a first wavelength; and ii) irradiating with a second LED light having a wavelength different from the first. Preferably, the first wavelength might be about 370 nm to about 395 nm, and more preferably about 380 nm to about 390 nm. Preferably, the second wavelength might be about 350 nm to about 380 nm, and more preferably about 360 nm to about 370 nm.

In an embodiment, one or more curing steps may also comprise irradiating with a UV light, a germicidal lamp, an excimer laser, or a combination thereof. Curing by irradiating with a UV light, a germicidal lamp and/or an excimer laser may occur concurrent with, prior to, or subsequent to irradiating with an LED light. In a preferred embodiment, each step of curing may comprise: i) irradiating with a first LED light having a first wavelength; ii) irradiating with a second LED light having a wavelength different from the first; and iii) irradiating with a UV light or a germicidal lamp. The resulting coating may have improved scratch, stain and scuff resistance over conventional coatings that do not incorporate diamond particles therein.

In an embodiment, one or more curing steps may comprise: i) first, irradiating with a UV light; ii) followed by irradiating with a first LED light having a first wavelength of about 370 nm to about 395 nm; ii) followed by irradiating with a germicidal lamp. In another embodiment, curing may comprise: i) first, irradiating with a UV light; ii) followed by irradiating with a first LED light having a first wavelength of about 370 nm to about 395 nm; and ii) irradiating with a second LED light having a wavelength different from the first of about 350 nm to about 380 nm. In a still further embodiment, curing may comprise: i) first, irradiating with a UV light; ii) followed by irradiating with a LED light having a first wavelength of about 370 nm to about 395 nm; and iii) irradiating with a UV light which may be the same or different from the UV light used in the first step.

According to an embodiment, the first average coating thickness is about 4 μm to about 40 μm, preferably about 6 μm to about 20 μm, and more preferably about 9 μm to about 12 μm. In another embodiment, the second average matrix coating thickness is about 4 μm to about 40 μm, preferably about 6 μm to about 20 μm, and more preferably about 12 μm to about 18 μm. In a certain embodiment, the first average coating thickness is about 9 μm to about 12 μm, and the second average matrix coating thickness is about 12 μm to about 18 μm.

An optional initial step to the method of making a multi-layer coated substrate, includes the step of making the LED curable coating. In an embodiment thereof, the LED curable coating is made by first mixing the ingredients of the resin with high speed agitation, followed by adding diamond particles and mixing with high speed agitation, wherein the diamond particles have an average particle size.

Yet another embodiment is a method of making an LED curable coating. The LED curable coating for use in this embodiment of the disclosure is the same as that described above. Likewise, the terms used in connection with this embodiment have the same meanings as defined in the embodiments above.

Specific embodiments of the disclosure will now be demonstrated by reference to the following general methods of manufacture and examples. It should be understood that these examples are disclosed solely by way of illustration and should not be taken in any way to limit the scope of the present disclosure.

### EXAMPLES

### Examples 1 & 2

Example 1 shows the results of testing coatings of the present disclosure cured using LED light followed by UV light (condition 1). Example 2 shows the results of testing coatings of the present disclosure cured using LED light at 385 nm followed by LED light at 365 nm (condition 2).

Condition 1 utilized four passes of LED 385nm, three passes LED 365 nm, and one pass of Aetek UV (380 mj/cm2). Condition 2 utilized four passes of LED 385 nm and three passes of LED 365 nm. The processing parameters are shown in Tables 1 and 2.

TABLE 1
Processing conditions for LED Curing For Examples 1 and 2

| | Mapper Data (1 Pass) Condition 1 | | | | | | | | | | |
|---|---|---|---|---|---|---|---|---|---|---|---|
| | Line | | | UVA | | UVB | | UVC | | UVV | |
| | Speed | Power | Height | mJ/cm2 | mW/cm2 | mJ/cm2 | mW/cm2 | mJ/cm2 | mW/cm2 | mJ/cm2 | mW/cm2 |
| Baldwin | 20 | 100 | 0.5 | 995 | 3134 | 7 | 51 | 38 | 127 | 2821 | 9584 |
| 385 nm | | | | | | | | | | | |
| LED | | | | | | | | | | | |
| Baldwin | 20 | 100 | 0.5 | 163 | 607 | 1.1 | 5 | 0 | 0 | 34.5 | 110 |
| 365 nm | | | | | | | | | | | |
| LED | | | | | | | | | | | |

TABLE 2
Processing conditions for Aetek final
Cure at 34fpm for Condition 1

| UVA | | UVB | | UVC | | UVV | |
|---|---|---|---|---|---|---|---|
| J/cm² | W/cm² | J/cm² | W/cm² | J/cm² | W/cm² | J/cm² | W/cm² |
| 0.380 | 0.811 | 0.338 | 0.762 | 0.053 | 0.109 | 0.196 | 0.438 |

TABLE 3
Formulations

| | | | Component/ | Sample 1A | Sample 1B |
|---|---|---|---|---|---|
| Name and Trade Name | | | Function | (grams) | (grams) |
| EC6360 | polyester acrylate | Eternal | Matrix/Binder | 13.42 | 13.42 |
| EB8602 | multifunctional | Allnex | Matrix/Binder | 24.92 | 24.92 |
| | urethane acrylate | | | | |
| SR833SX | tricyclodecane | Sartomer | Matrix/Binder | 15.34 | 15.34 |
| | dimehanol | | | | |
| | diacrylate | | | | |
| SR 351 | Trimethylopropane | Sartomer | Matrix/Binder | 5.37 | 5.37 |
| | triacrylate | | | | |
| Ebecryl | aliphatic urethane | Allnex | Matrix/Binder | 10 | |
| 8807 | diacrylate | | | | |
| Ebecryl | aliphatic urethane | Allnex | Matrix/Binder | | 10 |
| 8811 | diacrylate | | | | |
| ITX | ISOPROPYL- | | Co-initiator | 0.3 | 0.3 |
| | THIOXANTHONE | | | | |
| SR506A | isobornylacrylate | Sartomer | Matrix/Binder | 7.67 | 7.67 |
| Ebecry | 2- | Allnex | Matrix/Binder | 6.9 | 6.9 |
| 114 | phenoxyethylacrylate | | | | |
| SR 238 | Hexandiol | Sartomer | Matrix/Binder | 6.9 | 6.9 |
| | diacrylate | | | | |
| CN371 | amine coinitiator | Sartomer | Co-initiator | 3.42 | 3.42 |
| Speedcure | Benzophenone, | Lambson | Photoinitiator | 3.56 | 3.56 |
| BP | photoinitator | | | | |
| Speedcure | Photoinitiator | Lambson | Photoinitiator | 0.89 | 0.89 |
| 84 | | | | | |
| Lucrin | Photoinitiator, Ethyl-2,4,6 | | Photoinitiator | 2.7 | 2.7 |
| TPO | trimethylbenzoylphenyl | | | | |
| | phosphinate | | | | |
| SCMD 6- | Diamond Particles | | | 4 | 4 |
| 10 | 6-10 ums | | | | |

After processing according to the conditions above, the samples were tested and the results presented in Table 4 below.

Gloss is measured by using a BYK 60 degree gloss meter set in statistical mode for a total of 10 measurements to give an average gloss value.

For the Gardner gloss retention test, each coating layer was abraded with 30 passes using 100 grit sand paper and applying 2.1 lbs weight. A Gardner abrasion tester was used, which is available from BYK Gardner. After abrading, each sample was visually compared by a panel of test evaluators for retention of desired visual appearance—wherein the rank of visual appearance was visually assessed against standards on a scale of 0 to 1. A value of 0 is the best, meaning that the sample has minimal abrasion. A value of 1 is the worst, meaning that the sample has visually significant and noticeable abrasions. The percent gloss retained was calculated based on initial gloss and final gloss after the test.

The iodine stain test is conducted by placing a dropper full of iodine (size of dime) on the substrate and covering with a gauze strip and allowing it to remain for 1 min. The gauze strip is removed and sample is wiped with a damp rag having a small amount of isopropanol. A Delta b (Δb) value is obtained, which is a measure of the difference in b values between the control and a sample and indicates the degree of yellowing. The degree of yellowing is measured by use of a calorimeter that measures tristimulas color values of ‘a’, ‘b’, and ‘L’, where the color coordinates are designated as +a (red), −a (green), +b (yellow), −b (blue), +L (white), and −L (black).

TABLE 4
Results for Examples 1 and 2

| | | Sample 1A | Sample 1B |
|---|---|---|---|
| After processing | Gloss (average) | 67.5 | |
| under Condition 1 | Gardner % ret | 91.7 | 92.9 |
| | Iodine test | 9.5 | 18.7 |
| | 1 min delta b | | |
| After processing | Gardner % ret | 90.7 | 82.3 |
| under Condition 2 | Iodine test | 10.6 | 12.7 |
| | 1 min delta b | | |

As shown in Table 4, the results of Example 1 show that good wear resistance is achieved based on Gardner scratch testing for LED/UV cured materials (condition 1). Wear resistance was good using the combination of 365 nm and 385 nm (per condition 2), but stain resistance was not as good as resulting from condition 1 based on 1 min iodine test.

### Example 3

The following example illustrates the use of LED and Germicidal lamps to fully cure coatings of the present disclosure. Processing was done according to curing conditions 11 and 12 below (as shown in Tables 5, 6, 7). A summary of formulations is provided in Table 8. Test results are provided in Table 9.

The Control LG800 was cured by UV only; Pre-cure; 24 fpm UVA; 175 mj/cm2, 133 mW/cm2 (EIT puck), 1-pass, Final UV cure; 41 fpm, UVA; 495 mJ/cm2, 515 mW/cm2. The control formulation is provided in Table 8.

TABLE 5
Processing conditions for LED and Germicidal
Lamp Curing For Example 3

| | | | Baldwin 385 nm | Germicidal |
|---|---|---|---|---|
| Mapper Data (1 Pass) | Line Speed | | 20 | 20 |
| | Power | | 100 | n/a |
| | Height | | 0.5 | n/a |
| | UVA | mJ/cm² | 995 | 30 |
| | | mw/cm² | 3134 | 3 |
| | UVB | mJ/cm² | 7 | 40 |
| | | mw/cm² | 51 | 4 |
| | UVC | mJ/cm² | 38 | 226 |
| | | mw/cm² | 127 | 19 |
| | UVV | mJ/cm² | 2821 | 134 |
| | | mw/cm² | 9584 | 12 |

TABLE 6
Processing Conditions for Condition 11

| LED CURE 1 | | Germicidal Unit | |
|---|---|---|---|
| Baldwin 385 nm | | American UV Germicidal Unit | |
| Power (%) | 100 | # Lamps On | 36 |
| Height (in) | 0.5 | Conveyor Speed fpm | 20 |
| Conveyor Speed fpm | 20 | # Passes | 1 |
| # Passes | 4 | PPM O2 | 30 |
| Temp In | | N2 Flow rate scfm/each | 5 |

TABLE 7
Processing Conditions for Condition 12

| FED CURE 1 | | Germicidal Unit | |
|---|---|---|---|
| Baldwin 385 nm | | American UV Germicidal Unit | |
| Power (%) | 100 | # Lamps On | 36 |
| Height (in) | 0.5 | Conveyor Speed fpm | 20 |
| Conveyor Speed fpm | 20 | # Passes | 2 |
| # Passes | 4 | PPM 02 | 30 |
| Temp In | | N2 Flow rate scfm/each | 5 |

TABLE 8
Formulations for Example 3

| | | | | Sample A | | | | |
|---|---|---|---|---|---|---|---|---|
| | | | | (LED- | Sample B | Sample C | Sample D | Sample E |
| | | Component/ | Control | 05242016-1) | (LED- | (LED- | (LED- | (LED- |
| Trade Name | Supplier | Function | LG800 | (grams) | 05242016-7) | 05242016-8) | 06202016-1) | 06202016-6) |
| LG800 | | | | 97.5 | | | 98.5 | 93 |
| EC6360 | Eternal | Matrix/ | 22.61 | | 13.42 | 13.42 | | |
| | | Binder | | | | | | |
| EB8602 | Allnex | Matrix/ | 22.61 | | 24.92 | 24.92 | | |
| | | Binder | | | | | | |
| SR833SX | Sartomer | Matrix/ | | | 15.34 | 15.34 | | |
| | | Binder | | | | | | |
| SR 351 | Sartomer | Matrix/ | | | 5.37 | 5.37 | | |
| | | Binder | | | | | | |
| Ebecryl LED 02 | Allnex | Matrix/ | | | | | | |
| | | Binder | | | | | | |
| Ebecryl 8807 | Allnex | Matrix/ | | | 15 | | | |
| | | Binder | | | | | | |
| Ebecryl 8811 | Allnex | Matrix/ | | | | 10 | | |
| | | Binder | | | | | | |
| ITX | Escure | Co-initiator | | 0.1 | 0.1 | 0.1 | 0.1 | |
| ISOPROPYLTHIOX | | | | | | | | |
| ANTHONE | | | | | | | | |
| SR506A | Sartomer | Matrix/ | 6.96 | | 7.67 | 7.67 | | |
| | | Binder | | | | | | |
| Ebecry 114 | Allnex | Matrix/ | 6.26 | | 6.9 | 6.9 | | |
| | | Binder | | | | | | |
| SR 238 | Sartomer | Matrix/ | 6.26 | | 6.9 | 6.9 | | |
| | | Binder | | | | | | |
| CN371 | Sartomer | Co-Initiator | 3.46 | | 3.42 | 3.42 | | |
| Disperbyk 2008 | BYK | Dispersant | 0.39 | | 0 | 0 | | |
| Speedcure BP | Lambson | Photoinitiator | 3.6 | | 3.56 | 3.56 | | |
| Speedcure 84 | Lambson | Photoinitiator | 0.9 | | 0.89 | 0.89 | | |
| Orgasol 3501 EX D | Arkema | Texture | 1.01 | | | | | |
| NAT1 | | | | | | | | |
| Acematt 3600 | Degussa | Matting | 3 | | 6 | 5 | | |
| | | agent | | | | | | |
| Lucrin TPO | | Photoinitiator | | 2.5 | 2.5 | 2.5 | | |
| SCMD 6-10 | Scmd | Diamond | 4.15 | | 4.15 | 4.15 | | |
| | | Particles | | | | | | |
| Ominirad BL723 | Eternal | Photoinitiator | | | | | 1.5 | 3 |
| Ethyl-4- | | Co-initiator | | | | | | 4 |
| dimethylamino | | | | | | | | |
| benzoate, EDB | | | | | | | | |

TABLE 9
Results for Samples A and B

| | | Sample A; | Sample A; | Sample B; | Sample B; |
|---|---|---|---|---|---|
| | Control | Condition | Condition | Condition | Condition |
| | LG800 | 11 | 12 | 11 | 12 |
| Gloss | 24 | 46.2 | 58.5 | 52 | 61.4 |
| Gardner | 0 | 0 | 0 | 0 | 0 |
| Iodine delta b | 8 | 0.7 | 0 | 2.64 | 8.1 |
| value 1 min | | | | | |
| IR degree of | >95 | >85 | >85 | >85 | >85 |
| cure | | | | | |

TABLE 10
Results for Samples C, D and E

| | | Sample | Sample | Sample | Sample | Sample | Sample |
|---|---|---|---|---|---|---|---|
| | | C; | C; | D; | D; | E; | E; |
| | Control | Condition | Condition | Condition | Condition | Condition | Condition |
| | LG800 | 11 | 12 | 11 | 12 | 11 | 12 |
| Gloss | 24 | 61.9 | 58.2 | 37 | 28 | 37 | 37 |
| Gardner | 0 | 0 | 0 | 0 | 0 | 0 | 0 |
| Iodine | 8 | 2 | 1.52 | 0.38 | 0 | 0 | 0 |
| stain Delta | | | | | | | |
| b 1 min | | | | | | | |
| IR degree | >90 | >85 | >85 | >85 | >85 | >85 | >85 |
| of cure | | | | | | | |

The Gloss, Gardner and Iodine stain tests were performed in accordance with the protocols discussed with respect to Examples 1 and 2 above.

Degree of double bond cure for the LED cured coatings is estimated by comparing the intensity of the IR stretch for the C═C group around 1400 cm-1 of uncured liquid (0% cure) to cured coating (100% degree of cure). This is based on the relative ratio of the measured intensity of each peak relative to carbonyl intensity at ca 1700 cm-1 (constant). The 1400cm-1 stretch is absent in a fully cured coating indicating the polymerization of the C═CH2 in the acrylic resin. This would be 100% degree of cured. The results are presented as the IR degree of cure.

The results presented in Tables 9 and 10 show that good wear performance is achieved based on the Gardner test (0 rating) for both cure Conditions 11 and 12. Excellent stain resistance was observed on all examples for Conditions 11 and 12. As shown by the delta b values, stain resistance for the examples under both conditions was better than for the Control, which was cured only by UV.

### Example 4

In Example 4, LED light and Germicidal lamps were used to fully cure coatings of the present disclosure. Samples 4A, 4B and 4C further contain a Vazo catalyst (see Table 11).

Control LG800 formulation was cured by UV only; Pre-cure; 24 fpm UVA; 175 mj/cm2, 133 mW/cm2 (EIT puck), 1-pass, Final UV cure; 41 fpm, UVA; 495 mJ/cm2, 515 mW/cm2. Samples 4A, 4B and 4C utilized a UV precure step to set gloss: Pre-cure; 24 fpm UVA; 175 mj/cm2, 133 mW/cm2 (EIT puck), followed by cure conditions according to condition 11 above (see Tables 5 and 6). All coated samples containing the Vazo 52 catalyst were pre-heated to >100° F. prior to cure.

TABLE 11
Control and Formulations Containing Vazo 52 Thermal Initiator

| | | Sample 4A | Sample 4B | Sample 4C |
|---|---|---|---|---|
| | | (LED- | (LED- | (LED- |
| | Control | 08052016- | 08052016- | 08052016- |
| | LG800 | 1-11) | 2-11) | 3-11) |
| LG800^{†} | 100 | 97.5 | 97.5 | 97.5 |
| ITX | | 0.1 | 0.1 | 0.1 |
| Lucrin TPO | | 2.5 | 2.5 | 2.5 |
| *Vazo 52: catalyst | | 0.5 | 0.7 | 0.9 |
| *Acetone | | 1 | 2 | 2 |

^{†}The formulation for LG800 is provided in Table 8 above.
*The Acetone and Vazo 52 were pre-mixed to dissolve the catalyst.

TABLE 12
Effect of Vazo 52 Thermal Initiator on LED/Germicidal Cure

| | Control | | | |
|---|---|---|---|---|
| RESULTS | LG800 | Sample 4A | Sample 4B | Sample 4C |
| Gloss | 25 | 28 | 26 | 18.7 |
| Iodine stain | 8 | 1.4 | 1.4 | 3.4 |
| Delta b 1 min | | | | |
| Gardner | 0 | 0 | 0 | 0 |
| Gardner gloss ret | 97 | 89 | 90 | 85 |
| IR degree of cure | 100 | 100 | 100 | 100 |

The results in Table 12 show that good wear performance is achieved based on the Gardner test (0 rating). Excellent stain resistance was observed on all samples containing the vazo catalyst as evident by the low delta b values, which are significantly lower that the control.

### Example 5

These studies explore methods to mitigate oxygen inhibition of curing by utilizing reactive chemicals and a nitrogen atmosphere to improve the surface cure for UV/LED cured floor coatings. The types of materials studied may be broken down into high viscosity urethane acrylates, mercapto modified polyester acrylate resins, and LED photoinitiators within a base formulation for each series of formulations. (See Tables 13, 14). Within these comparative studies using a base formulation with the same materials, the effect of atmosphere processing conditions (i.e., air vs. nitrogen) on degree of cure, glass transition temperature (Tg), mechanical properties, and scratch, scuff, and stain performance will be described. The properties of cured UV/LED coatings include double bond conversion determined by FTIR, mechanical tests to determine % elongation at break, DMA properties to determine level of cross linking, and thermal analysis to determine glass transition temperatures.

Three studies are included in this example:
1) The effect of double bond equivalent weight (DBEW) within the formulation on degree of cure, mechanical testing, and performance data. (See Table 15.)
2) The effect of photoinitiator type, phosphine oxide based TPO, TPO-L vs. 3-ketocumarin on cure of LED formulations. (See Table 16.)
3) The effect of high viscosity urethane acrylate and thiol based acrylate on LED cure (See Table 17.)

### Experimental

The materials used in this study are shown in Table 1. Tables 2 through 5 show the various formulations used in each of the four studies.

| Component | Function |
|---|---|
| Polyester acrylate E6360/Eternal | Matrix/Binder |
| Highly functional urethane | Matrix/Binder |
| acrylate EB8602 Allnex | |
| monoacrylate 1 SR506 | Matrix/Binder |
| Isobornylacrylate | |
| monoacrylate 22-Phenoxyethyl | Matrix/Binder |
| acrylate | |
| Diacrylate 1 SR833S | Matrix/Binder |
| Tricyclodecane dimethanol | |
| diacrylate | |
| Diacrylate2 SR238 | Matrix/Binder |
| Hexanedioldiacrylate | |
| Triacrylate 1 SR351 | Matrix/Binder |
| Trimethylolpropane Triacrylate | |
| Ebecryl LED 02, mercapto based | Matrix/Binder |
| acrylate resin, Allnex | |
| Ebecryl 8807, Aliphatic UA high | Matrix/Binder |
| viscosity, Allnex | |
| Ebecryl 8811, Aliphatic UA, | Matrix/Binder |
| High Viscosity, Allnex | |
| LED/UV Photoinitiators | |
| Diphenyl(2,4,6- | LED/UV photo initiator |
| trimethylbenzoyl)phosphine | |
| oxide (TPO) | |
| ISOPROPYLTHIOXANTHONE | Co-initiator |
| (ITX) | |
| Amine co-initiator | Co-initiator |
| Ominirad BL723, IGM Resins | LED/UV photoinitiators |
| LFC3644 IGM experimental 3- | LED/UV photoinitiator |
| ketocumarin, IGM Resins | |
| Benzophenone | UV Photoinitiator |
| Hydroxycyclohexyl-1-phenyl | UV Photoinitiator |
| methanone | |
| Additives | |
| Hard Particles | |

TABLE 14
Effect of High MW Aliphatic UA on Surface
Cure with LED Lamps 385, 365.

| | Description |
|---|---|
| | Control UV Cured |
| Component | Amt (g) |
| Polyester acrylate EC6360 Eternal | 13.4 |
| Highly functional urethane acrylate | 24.9 |
| EB8602 Allnex | |
| monoacrylate 1 SR506 | 7.7 |
| Isobornylacrylate | |
| monoacrylate 2 2-Phenoxyethyl | 6.9 |
| acrylate | |
| Diacrylate 1 SR833S Tricyclodecane | 15.3 |
| dimethanol diacrylate | |
| Diacrylate 2 SR238 | 6.9 |
| Hexanedioldiacrylate | |
| Triacrylate SR351 | 5.4 |
| Trimethylolpropane Triacrylate | |
| Ebecryl 8811, Aliphatic UA, High | |
| Viscosity | |
| ITX, isopropylthioxanthone | |
| Amine co-initiator CN371 Amine | 3.4 |
| synergist Sartomer | |
| Benzophenone | 3.6 |
| 1-Hydroxycyclohexyl-1-phenyl | 0.9 |
| methanone | |
| Diphenyl(2,4,6- | |
| trimethylbenzoyl)phosphine oxide | |
| (TPO) | |
| Hard Particles: SCMD diamond B 6- | 4.0 |
| 10 um | |
| DBEW/1,000 g | 60 |
| Viscosity cps 77F | 550 |

TABLE 15
Effect of DBEW on LED Properties Cured
in Air and Nitrogen Atmosphere.

| | Description | | |
|---|---|---|---|
| | A | B | C |
| Component | Amt (g) | Amt (g) | Amt (g) |
| Polyester acrylate EC6360 Eternal | 15.5 | 9 | 0 |
| Highly functional urethane acrylate EB8602 | 28.7 | 35.2 | 48 |
| Allnex | | | |
| Diacrylate 1 Tricyclodecane dimethanol | 17.7 | 17.7 | 19.2 |
| diacrylate | | | |
| Diacrylate2 SR238 Hexanedioldiacrylate | 8 | 8 | 8.6 |
| Triacrylate Trimethylolpropane Triacrylate | 6.2 | 6.2 | 6.7 |
| SR351 | | | |
| Ebecryl 8811, Aliphatic UA | 11.5 | 11.5 | 12.5 |
| ITX, ISOPROPYLTHIOXANTHONE | 0.3 | 0.3 | 0.4 |
| Benzophenone | 1.2 | 1.2 | 1.3 |
| 1-Hydroxycyclohexyl-1-phenyl methanone | 0.6 | 0.6 | 0.6 |
| Diphenyl(2,4,6-trimethylbenzoyl)phosphine | 5.8 | 5.8 | 6.3 |
| oxide (TPO) | | | |
| Hard Particles SCMD diamond B 6-10 um | 4.6 | 4.6 | 5 |
| DBEW/1,000 g | 62 | 68 | 76 |
| Viscosity cps 77F | 1400 | 2250 | 2000 |

TABLE 16
Effect of TPO vs. 3-Ketocumarin Photoinitiators
on LED Properties.

Description

| | D | E | F |
|---|---|---|---|
| Component | Amt (g) | Amt (g) | Amt (g) |
| Polyester acrylate EC6360 | 0.0 | 0.0 | 0.0 |
| Eternal | | | |
| Highly functional urethane | 48.1 | 48.1 | 48.1 |
| acrylate EB8602 Allnex | | | |
| Diacrylate 1 Tricyclodecane | 19.2 | 19.2 | 19.2 |
| dimethanol diacrylate | | | |
| Triacrylate Trimethylolpropane | 6.7 | 6.7 | 6.7 |
| Triacrylate SR351 | | | |
| ITX, | 0.4 | 0.4 | 0.4 |
| ISOPROPYLTHIOXANTHONE | | | |
| Diacrylate2 SR238 | 8.7 | 8.7 | 8.7 |
| Hexanedioldiacrylate | | | |
| Benzophenone | 1.3 | 1.3 | 1.3 |
| Hydroxycyclohexyl-1-phenyl | 0.6 | 0.6 | 0.6 |
| methanone | | | |
| Diphenyl(2,4,6- | 6.3 | | |
| trimethylbenzoyl)phosphine | | | |
| oxide (TPO) | | | |
| Ominirad BL723 nonyellowing | | 6.3 | |
| blend PI for LED 365 nm | | | |
| LFC3644 IGM experimental 3- | | 0.0 | 6.3 |
| ketocumarine | | | |
| EDB (dimethylaminobenzoate) | | 3.8 | 3.8 |
| Hard Particles SCMD diamond | 5.0 | 5.0 | 5.0 |
| B 6-10 um | | | |
| DBEW/1,000 g | 76 | 76 | 76 |
| Viscosity cps 77F | 700 | 625 | 1150 |

TABLE 17
Effect of Oligomers on LED Properties.

Description

| | G | H |
|---|---|---|
| Component | Amt (g) | Amt (g) |
| 2 functional Polyester acrylate | 0.0 | 0.0 |
| acrylate EC6360 Eternal | | |
| Highly functional urethane | 47.1 | 47.1 |
| acrylate EB8602 Allnex | | |
| Diacrylate2 Tricyclodecane | 8.5 | 8.5 |
| dimethanol diacrylate | | |
| Triacrylate Trimethylolpropane | 6.6 | 6.6 |
| Triacrylate SR351 | | |
| Ebecryl LED 02, Thiol based | 24.6 | 0.0 |
| resin | | |
| Ebecryl 8807, Aliphatic UA high | 0.0 | 24.6 |
| viscosity 2686000, f = 2 | | |
| ITX, | 0.4 | 0.4 |
| ISOPROPYLTHIOXANTHONE | | |
| Benzophenone | 1.2 | 1.2 |
| Hydroxycyclohexyl-1-phenyl | 0.6 | 0.6 |
| methanone | | |
| Diphenyl(2,4,6- | 6.1 | 6.1 |
| trimethylbenzoyl)phosphine | | |
| oxide (TPO) | | |
| Hard Particles | 4.9 | 4.9 |
| DBEW/1,000 g | 76 | 76 |
| Viscosity cps (77F) | 1800 | 7700 |

Table 14 summarizes the UV cured formulation used in this study for comparison to LED/UV cured formulations. Table 15 shows the formulation comprised of a combination of polyester acrylate, urethane acrylate, mono, di and trifunctional acrylates along with overall double bond equivalent weight (DBEW)/gm resin. The DBEW is calculated by dividing the C═C gm equivalent weight for each material by the amount of material (grams) to get equivalents of C═C. The summation C═C equivalents for each material divided by total weight gives the double bond equivalent weight. All additives have been left out of this calculation including photoinitiators and hard particles. To simplify formulations, the DBEW/g has been multiplied by 1,000 to give a whole number as DBEW/1000 g.

Testing Methods

Test Tile Preparation:

All performance testing for scuff, stain and abrasion was performed on a floor tile substrate to isolate the properties of the topcoats. All formulations were coated onto the tile substrate using a #6 wire wound rod to give approximately 0.6 to 0.7 mils and subsequently cured the conditions set out in Tables 18 and 19.

TABLE 18
UV process conditions used for control UV sample.

| | | UVA | | UVB | | UVC | | UVV | |
|---|---|---|---|---|---|---|---|---|---|
| Lamp | Line speed, fpm | J/cm² | W/cm² | J/cm² | W/cm² | J/cm² | W/cm² | J/cm² | W/cm² |
| Precure | 55 | 0.350 | 1.040 | 0.278 | 0.796 | 0.028 | 0.128 | 0.137 | 0.389 |
| Final Cure | 55 | 0.405 | 0.997 | 0.341 | 0.786 | 0.048 | 0.127 | 0.202 | 0.463 |

TABLE 19
LED/UV Processing Conditions At Lamp Head to Substrate of 1.5 inches.

| | Line | | | | | | | | |
|---|---|---|---|---|---|---|---|---|---|
| | speed, | UVA | | UVB | | UVC | | UVV | |
| Lamp | fpm | J/cm² | W/cm² | J/cm² | W/cm² | J/cm² | W/cm² | J/cm² | W/cm² |
| Baldwin | 20 | 1038 | 3968 | 52 | 185 | 2 | 8 | 2242 | 8487 |
| 385 nm | | | | | | | | | |
| LED SP50 | | | | | | | | | |
| Optics | | | | | | | | | |
| 4 passes | 20 | 4152 | 3968 | 208 | 185 | 8 | 8 | 8968 | 8487 |
| Baldwin | 20 | 1700 | 6481 | 41 | 147 | 3 | 12 | 257 | 961 |
| 365 nm | | | | | | | | | |
| LED SP50 | | | | | | | | | |
| Optics | | | | | | | | | |
| 4 passes | 20 | 6800 | 6481 | 164 | 147 | 13 | 12 | 1028 | 961 |

The coated tile substrate or wood was preheated to 85° F. after application of coating to allow for flow of the coating prior to UV or LED/UV cure processing. Laminate films were prepared by coating 2.6 mil rigid PVC film with the coating that was mounted on a glass plate prior to processing.

Gloss Testing:

Gloss was measured by using a BYK-Gardner 60° gloss meter set in statistical mode for a total of 10 measurements to give an average gloss value.

Viscosity:

Viscosity was measured by using a Brookfield RVT Viscometer #6 spindle at 100 rpm, 77° F.

Scratch Resistance:

Scratch Resistance was measured using a modified BYK Gardner abrasion tester. Each coating layer was abraded using a proprietary method. After abrading, each sample was visually assessed using the scale of ‘1’ for minimal damage and ‘2’ for severe damage. The percent gloss retained was calculated based on initial gloss and final gloss after the test.

Stain Resistance:

An iodine stain test was conducted by placing a dropper full of iodine (the size of a dime) on the substrate and allowing it to remain for 1 min. The sample was wiped with a damp rag and the color was measured with a sphere spectrometer from X-rite model SP64. The CIE L*a*b* color scale was used for color measurements. A Delta b (Δb) value was obtained, which is a measure of the difference in b values between the control and a sample and indicates the degree of yellowing. The degree of yellowing was measured by use of a calorimeter that measures tristimulas color values of ‘a’, ‘b’, and ‘L’, where the color coordinates are designated as +a (red), −a (green), +b (yellow), −b (blue), +L (white), and −L (black).

Double Bond Conversion:

The samples were scanned using a Cary 620 FTIR spectrometer with a diamond ATR accessory with a ZnSe engine. The samples were placed directly on the sample compartment base plate of the spectrometer without a salt crystal. Analysis was performed in absorbance mode using 64 scans at 8 cm⁻¹ resolution. Degree of double bond cure for the LED cured coatings was estimated by comparing the intensity of the IR stretch for the C═C group around 1400 cm⁻¹ of uncured liquid (0% cure) to cured coating (100% degree of cure). This is based on the relative ratio of the measured intensity of each peak relative to carbonyl intensity at about 1700 cm⁻¹ (constant). The 1400 cm⁻¹ stretch is absent in a fully cured coating indicating the polymerization of the C═CH₂ in the acrylic resin. This would be 100% degree of cure. The results are presented as the IR degree of cure.

UV Process Parameters for UV and LED/UV Cure:

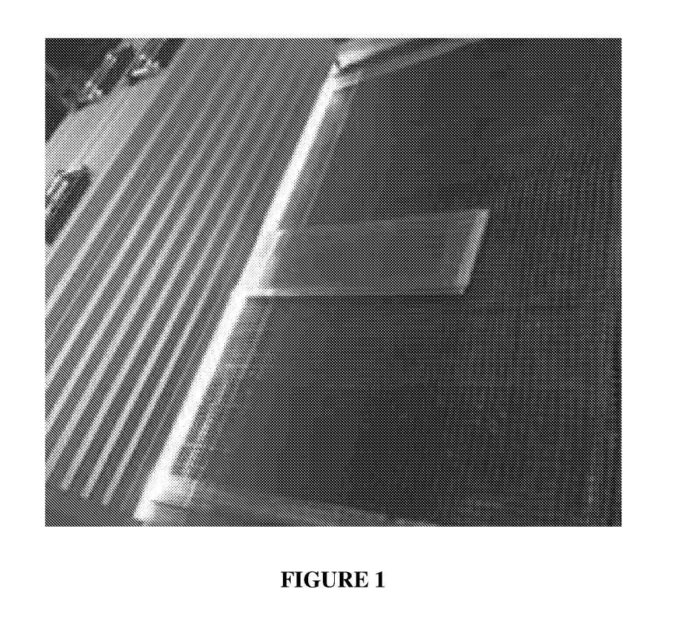

Two types of UV cure equipment were used for studies described in this example.
1) Milec UV System, Inc. with conveyor system; equipped with four 320 watts/inch mercury standard medium pressure Mercury Hg bulbs (Table 6). Samples were run with one pass for precure and two passes for final cure for a total of 1160 mJ/cm² UVA energy density.
2) Baldwin 365 nm and 385 nm LED's side by side equipped with SF50 optics (FIG. 1). Data was recorded using an EIT Power Mapper for each specific UV regime UVA, UVB, UVC, and UVV.

All samples coated were subjected to four passes of LED 385 nm and LED 365 nm at 20 fpm at a distance of 1.5 inches with no additional UV cure (FIG. 1). The processing parameters and radiometry values are given in Table 7.

Samples were cured in air or under a nitrogen atmosphere by using an enclosed metal chamber equipped with a quartz plate on top with an inlet and outlet for nitrogen purge and a removable sealed plate to allow for inserting samples. All samples were purged with nitrogen for a period of 30 seconds prior to LED/UV exposure to 385 nm and 365 nm LED lamps.

Differential Scanning Calorimetry:

DSC experiments were conducted using a TA instrument Model Q-2000 Differential Scanning Calorimeter (DSC). About 5.0 mg of the samples were weighed into an aluminum pan and analyzed using a TA Instrument. Initial and reheat data was obtained while heating the samples from −50° C. to 190° C. at a rate of 20° C./min. in a nitrogen atmosphere. The samples were quench-cooled using the RCS-90(chiller) between the initial and reheat scans.

Mechanical Testing:

All mechanical testing was conducted using a Instru-Met instron at a rate 0.5″/min. Samples were prepared by using machined 0.5.00 inch×6.00 inch template to prepare samples of coating/film composites. Data is summarized in Table 20.

TABLE 20
Summary of Mechanical Properties of Coated Film Composites.

| | A | B | C | D | E | F | G | H |
|---|---|---|---|---|---|---|---|---|
| Air Break elongation % | 7.6 | 7.9 | 6.9 | 4.8 | 5.9 | 6.2 | 6.4 | 5.9 |
| Nitrogen Break elongation % | 7.4 | 6.6 | 5.2 | 5.9 | 5.8 | 6.4 | 6 | 5.8 |

Mechanical Analysis of LED Cured Formulations Using DMA:

An approach to estimating the degree of cross linking utilized a TA Instruments Model Q-800 Dynamic Mechanical Analyzer (DMA) with tension film clamp. Nominally 0.6 mil coatings were prepared on a 2.6 mil PVC carrier film and cured by UV and LED in air and nitrogen atmosphere. A strain sweep at 100C was conducted to determine the degree of crosslink density of various UV LED formulations.

Results and Discussion

Effect of Formulation and Air vs. Nitrogen LED Cure on Scuff Resistance

An important goal of floor coating technology is to keep floors looking new longer through improved scuff resistance, scratch resistance, stain resistance, and clean ability. Scuff resistance is the ability of the flooring structure to withstand marks from shoe soles or high heel stilettos by providing a coating surface that exhibits superior wear resistance and easy cleanability. The scuff test was developed to determine how effectively coating formulations performed when marked by a rubber sole. After scuffing a sample, the sample is wiped with a dry cloth and rated based on visual appearance of the remaining scuff mark. A rating of 1 indicates no sign of scuff and rating 2 is indicates the presence of scuff marks.

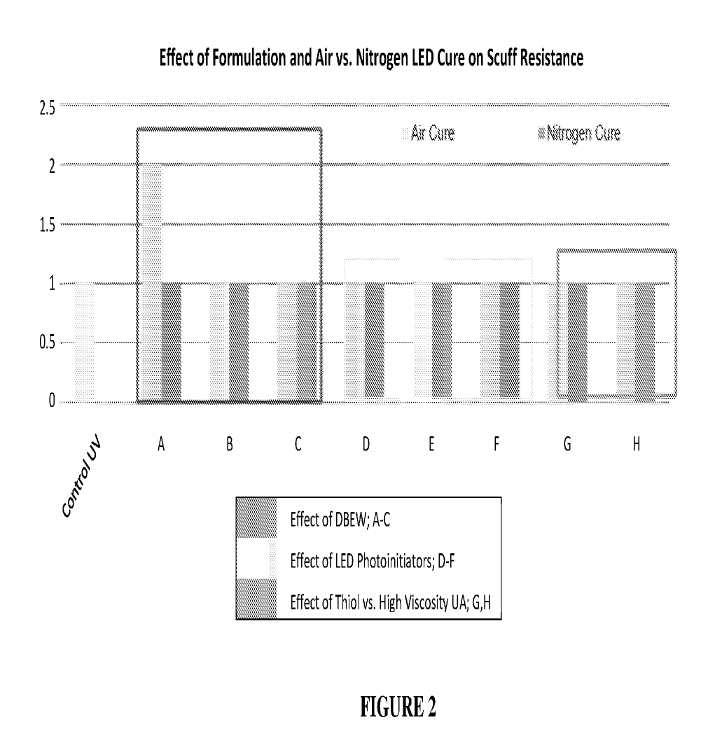

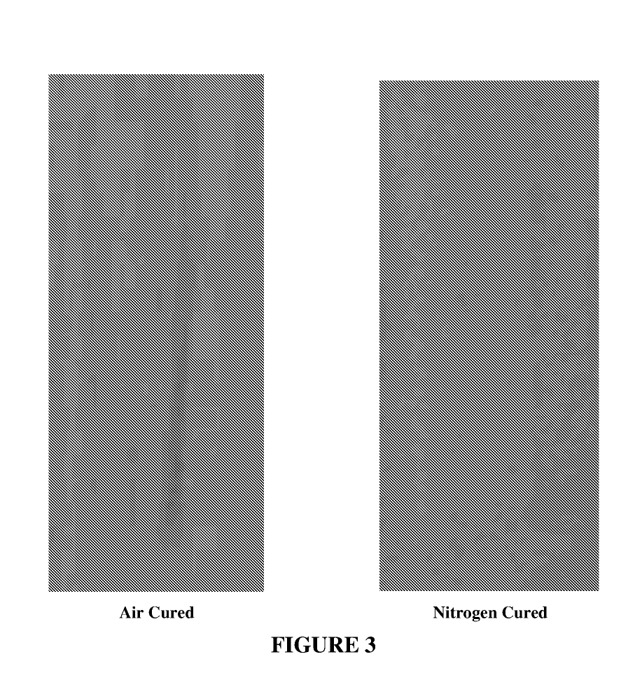

FIG. 2 provides a bar chart of scuff resistance for each formulation LED cured under air and nitrogen. Overall, the LED/UV formulation tested and atmosphere of cure, air vs. nitrogen, had little effect on scuff resistance, as noted by the ‘1’ rating. This indicates that sufficient surface cure was achieved by using UV/LED arrays that resulted in a hard cured surface to resist scuff marks. The control UV cured formulation using medium pressure Hg lamps was found to give a rating of ‘1’ indicating no scuff marks present. The exception was Formulation A cured in air, which exhibited scuff marks. (FIG. 3.) This same coating cured in a nitrogen atmosphere did not show scuff marks indicating a higher degree of crosslinking is achieved at the surface. (FIG. 3.)

Effect of Formulation and Air vs. Nitrogen LED Cure on Gardner Scratch:

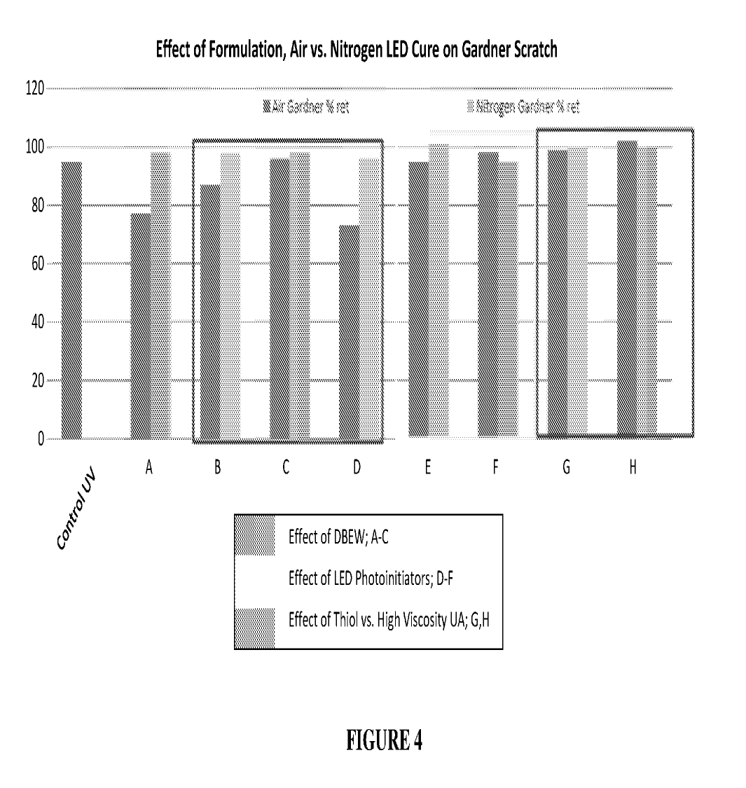

Table 21 summarizes the impact of formulation and atmosphere, air versus nitrogen. LED cure on Gardner Scratch as a visual ranking of 1 best, 2 worst and as percent gloss retained in bar graph. (FIG. 4.)

TABLE 21
Summary of Gardner Scratch Results For Formulations Cured in Air and Nitrogen.

| | Control | Control | | | | | | | | |
|---|---|---|---|---|---|---|---|---|---|---|
| | UV | LED | | | | | | | | |
| Description | Cured | cured | A | B | C | D | E | F | G | H |
| Air, Gardner Scratch | 1 | 2 | 1 | 1 | 1 | 1 | 1 | 1 | 1 | 1 |
| Rate: 1 Light; 2, Severe | | | | | | | | | | |
| Air, Gardner % retained | 95 | | 77 | 87 | 96 | 73 | 95 | 98 | 99 | 102 |
| N2, Gardner Scratch Rate: | | 1 | 1 | 1 | 1 | 1 | 1 | 1 | 1 | 1 |
| 1 Light; 2 Severe | | | | | | | | | | |
| N2, Gardner % retained | | | 98 | 98 | 98 | 96 | 101 | 95 | 100 | 100 |

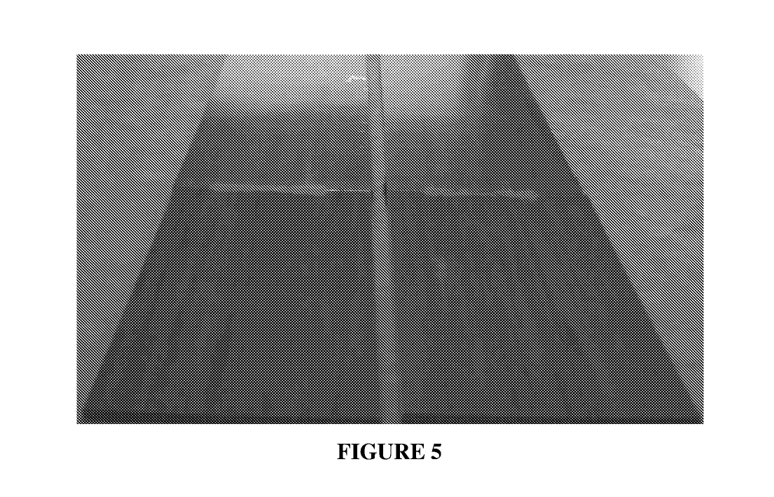

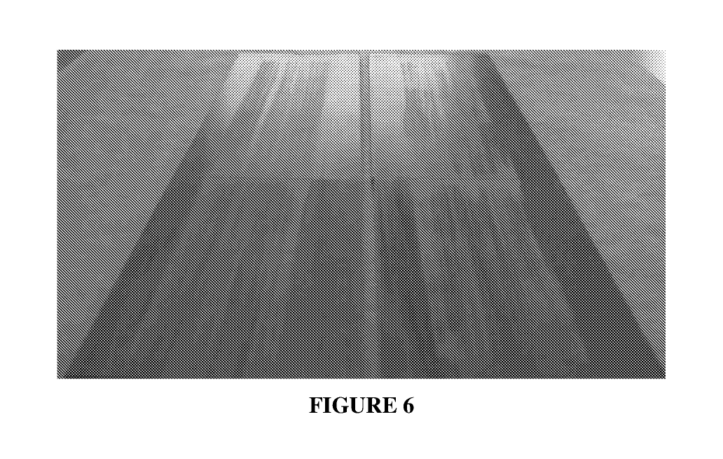

All formulations in this study contained the same type and weight percent of hard particles. Virtually no effect from air versus. nitrogen atmosphere during LED cure was observed on Gardner scratch performance for LED formulations. Almost all formulations were rated as ‘Light’ damage with gloss retention values after testing were greater than 89% based on initial gloss before testing and final gloss measurements after testing. (FIG. 5.) The influence of DBEW for Formulations A, 60; B, 67; and C, 76, did not have any dramatic effect on surface scratch properties indicating that the resin materials were sufficiently cured to hold the hard particles within the matrix. Similarly, no effect from the type of LED photoinitiator, TPO/ITX for formulation D, phosphine oxide based TPO-L formulation E versus 3-ketocumarine for formulation F was observed on Gardner scratch results. The exception was curing the UV control formulation by LED/UV arrays where severe scratch damage was observed (FIG. 6). This is due to insufficient cure of the resin matrix, thereby giving rise to failure of the surface to hold the hard particles, thereby leading to catastrophic failure.

Effect of Formulation on Initial Yellowing

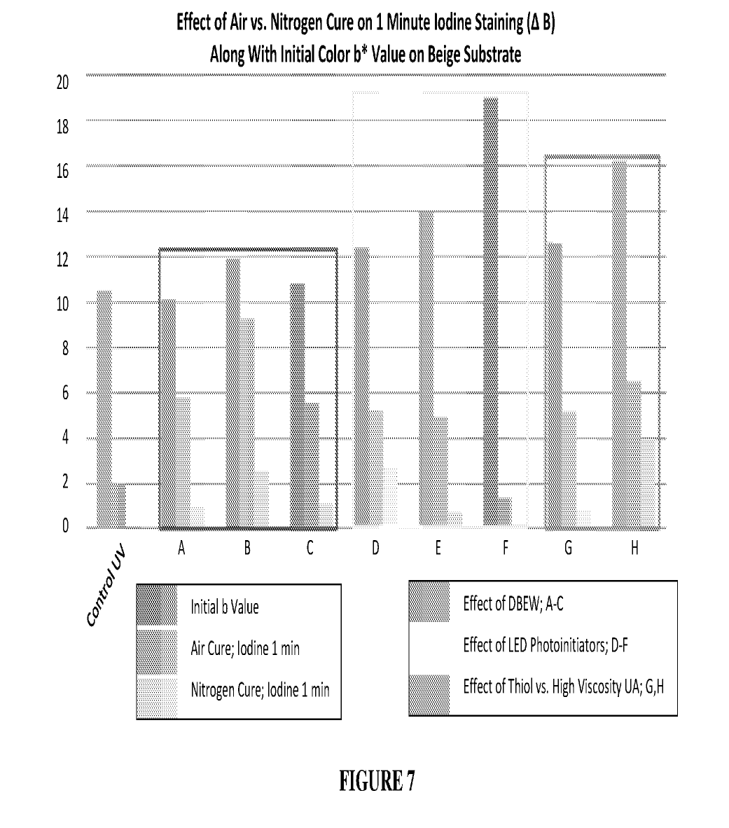

Color stability of the coatings after LED cure was determined by using a XRite SP64 flash spectrometer to record initial tristimulus L*a*b* values. In general, the bar graph shows formulations D & E containing 3-ketocumarine initiators show more yellowing versus formulations containing TPO and ITX (FIG. 7) by the higher b* values. The control cured by UV was found to have the lowest b* value of 10.2 whereas formulations D and E containing 5% of BL723 and LFC 3644 were found to have higher b* values of 14 and 19, respectively, for the same base resin compositions. The exception was Formulation H containing TPO/ITX and a high MW aliphatic urethane acrylate that was found to have a high color b* value of 16.3.

Overall the staining observed, with the exception of Formulations F & H, would likley not impact the color of medium or dark wood stains such as gunstock, Sumatra, cherry, saddle, mocha, or midnight. Lighter colors such as natural and harvest could be effected by the coating's initial b* values.

One Minute Iodine Staining: Effect of Air vs. Nitrogen Cure

Effect of process conditions on one minute iodine stain resistance as determined by the delta b* color value shows that UV LED cure under nitrogen performed better than LED cure under air atmosphere due to improved surface cure. The lower the delta b stain value, the better resistance to iodine staining observed as shown in the bar graph in FIG. 7. It is important to note that formulations having a higher initial b* value than the UV control will result in masking of the staining due to iodine and result in a false b* value.

Air LED/UV Cure:

The best one minute iodine stain resistance in air is observed for the UV control cured versus the remainder of the LED formulations indicating better surface cure using Hg lamps. Although Formulation F had the lowest recordable Delta b value after the 1 minute stain test, it also had the highest initial b* color that would mask the delta b value of the iodine stain. In comparing Formulations A, B, C, in the series of increasing DBEW from 62 to 76, no trend in improved iodine stain resistance was observed. Formulation A with DBEW of 60 and formulation C with DBEW of 76 that have similar initial b* color values of ca 5.6 which is three times to that of the UV control. Similarly in comparing the LED photoinitator series D, E, F, the TPO/ITX formulation D and phosphine oxide TPO-L based phtoinitiator E were similar on stain resistance.

Nitrogen LED/UV Cure:

The improvement in stain resistance under a nitrogen atmosphere is due to mitigation of oxygen inhibition during the UV initiated polymerization. Again, there was no observed trend in increasing DBEW in the series A, B, C on stain resistance. In comparing the LED photoinitator series D, E, and F, an improvement was noticed for Formulation E containing the phosphine oxide blend (TPO-L) BL723 Db=0.74 versus Formulation D containing TPO, Db=2.7. In comparing the effect of mercapto based resin versus high viscosity UA in the series G and H, an improvement in stain was observed for Formulation G containing the mercapto based resin LED2; Db=0.8 versus 4 for UA EB8807. The other factor contributing to improved stain resistance is the increase in viscosity of these formulations that helps mitigate oxygen diffusion into the coating.

Effect of Formulation Cured by LED in Air vs. Nitrogen on C═C Cure By Infrared Analysis

A summary of carbon-carbon double bond conversions is given in Table 22.

TABLE 22
Summary of Double Bond Conversions for
Formulations Cured in Air Vs. Nitrogen.

| | Control UV | Base C1 | A | B | C | D | E | F | G | H |
|---|---|---|---|---|---|---|---|---|---|---|
| IR conversion air | 100 | 7 | 58 | 66 | 57 | 44 | 69 | 58 | 75 | 58 |
| IR conversion nitrogen | | 89 | 83 | 78 | 86 | 80 | 87 | 61 | 81 | 74 |
| Delta C═C change | | 81 | 12 | 12 | 29 | 36 | 18 | 3 | 6 | 16 |

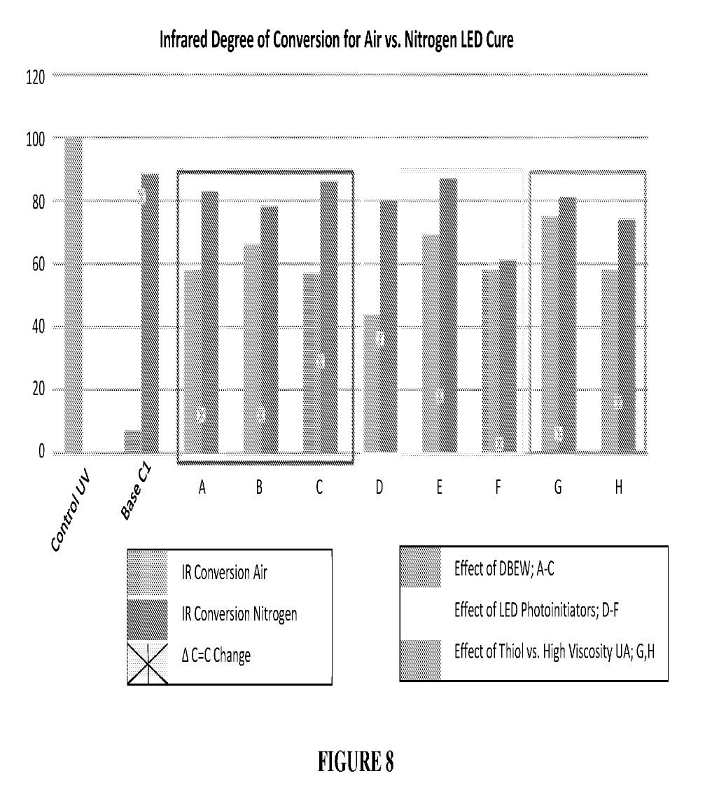

The control UV formulation cured in air was found to have 100% conversion by IR using standard medium pressure Hg arc lamp processing conditions of 1330 mj/cm² and 900 mW/cm². The same formulation designated as Base Cl cured by LED 385 nm and LED 365 nm in air was found to have a low IR conversion of only 7% after 8 passes to get a tack free surface, which is twice as many as other formulations in this study. In contrast, curing the UV formulation under a nitrogen atmosphere using LED's resulted in a high double bond conversion of 88%. The difference in cure in air versus nitrogen is well documented where oxygen inhibition is interfering with radical formation quenching reactions, and scavenging reactions. (Jo Ann Arceneaux, “Mitigation of Oxygen Inhibition in UV-LED, UVA and Low Intensity UV Cure”, UV+EB Technology, Vol. 1 No. 3, pp 48-56.) Formulation G was found to have the highest double bond conversion of 75% when cured under LED/UV air. This formulation has a DBEW of 76 and contains 47% of a highly functional urethane acrylate and ca. 25% of the mercapto based resin LED 2 that results in a high degree of reactivity. (FIG. 8.)

The formulation with the least amount of C═C double bond conversion change was Formulation F that went from 58% conversion in air to 61% conversion in nitrogen. This formulation contained the 3-ketocumarin photoinitiator LFC3644 at 5% wt. In contrast, Formulation E contained the LED phosphine oxide TPO-L photoinitator blend identified by IGM as Omnirad BL723 that was found to give a higher conversion of 69% in air and 87% in nitrogen. (Table 9.) These differences in cure are attributed to the combination of benzophenone derivatives for surface cure and the phosphine oxide based photoinitiator TPO-L mixture vs. LFC3644. (A. Freddi, M. Morone, G. Norcini, “Design of New 3-ketocoumarins for UV/LED Curing”, UV & EB Technology, Vol 2 No 3, pp 46-51.)

In comparing the degree of double bond conversion for the series A, B, C no trend of increasing double bond conversion with increasing DBEW was observed for the range 60 to 76. The range of double bond conversion was 58-66% for LED air cure and 78-86% for LED nitrogen cure. (FIG. 8.) The expected outcome would have been a higher double bond conversion for Formulation C with the lowest DBEW due to less of an effect of diffusion limitations during acrylate polymerization.

In the series containing different LED initiators D, E, and F, the highest double bond conversion was observed for formulation E containing the phosphine oxide based photoinitiator Omirad BL724 with 69% conversion in air and 87% conversion in nitrogen atmosphere. (FIG. 8.) An improvement in double bond conversion was noted in the series G and H where the mercapto based resin LED2 gave a higher double bond conversion than the high viscosity urethane acrylate EB8807 when cured in air or nitrogen atmosphere. (FIG. 8.) In this instance, the mercapto based resin had more of an impact on double bond conversion then the high viscosity UA. It was expected that the high viscosity UA would have the potential to slow down oxygen diffusion into the coating by increasing the overall viscosity of the formulation. The delta C═C change for air versus nitrogen shows that the worst is the UV Base Cl formulation followed by D (TPO/ITX), C (DBEW 76), and E (phosphine oxide based photoinitiator).

Mechanical Properties of LED Cured Coatings on RVF: Instron Studies

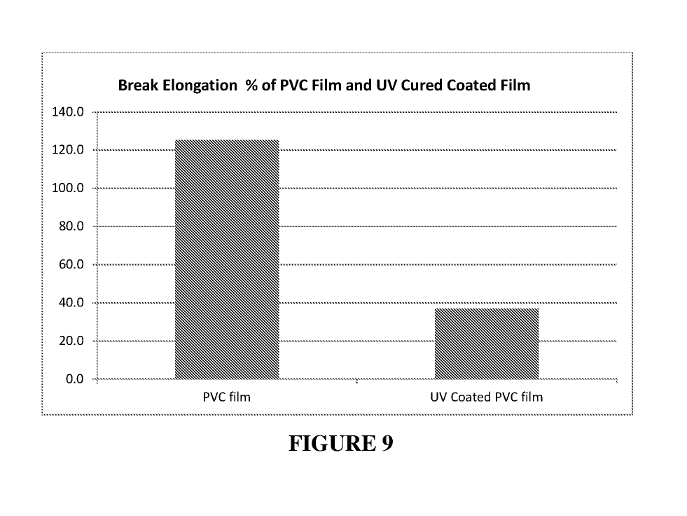

To gain an understanding regarding the crosslink density of the acrylate cured coatings, nominally 0.6mi1 films were prepared on a 2.6 mil rigid polyvinylchloride (PVC) carrier film and evaluated by mechanical tests. Percent elongation at break was determined at the point of breakage of the film composite structure. The function of the PVC film carrier is to provide a backing to allow for relative comparisons to be made between coating formulations that would otherwise be too brittle to test by using an Instron. All coatings were applied in machine direction of the film. The stress strain curve for the carrier PVC film exposed to UV process shows the yield elongation at 5.5% and break elongation of 125%. Test results for the UV cured ‘control’ coating on the RVF shows a dramatic in elongation at break to 37% thus showing the influence of the coating on mechanical properties. (FIG. 9.) Table 20 shows the mechanical test values which are an average of 3 runs.

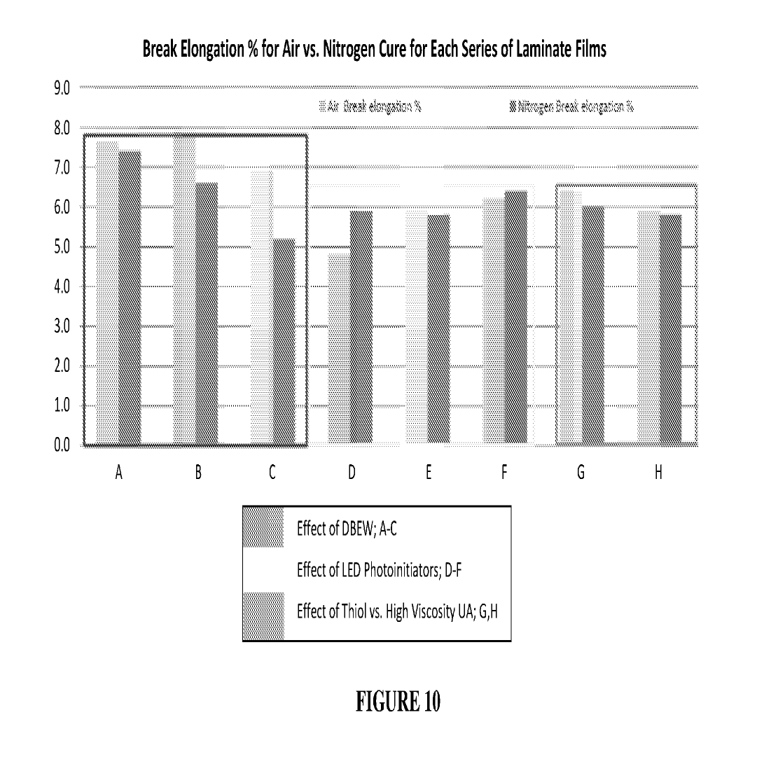

Bar graphs for break elongation % for each LED coating series studied are illustrated in FIG. 10. The base coating/PVC laminate that was UV cured was found to have a break elongation 3 to 4 times greater to that of LED cured coatings. The elongation at break for the UV control was 37% versus 11% or less for all other LED cured coatings tested. (Table 20.)

These differences are attributed to the overall total UVA and UVV energy density and peak irradiance by the two different cure methods. Both the energy density and peak irradiance is dramatically higher for LED cured coatings versus conventional UV cured films. The total energy density for LED/UV cured films is UVA, 13.6 J/cm2, versus 0.9 J/cm2 for the UV cured film. UV/LED's have been reported to transfer 15%-25% of the received electrical energy into light with the remaining 75-85% transferred as heat. (Jennings, Sara, “UV-LED Curing Systems: Not Created Equal,” Presented at 2016 Rad Tech International.) Even though the DBEW for the UV cured coating is 60 versus 62-76 for higher functionality LED coatings, the magnitude of difference is not expected. (FIG. 10.)

In comparing the effect of DBEW on break elongation in air, formulation B having a DBEW of 68 was found to have an elongation of 7.9% which is similar to formulation C having a DBEW of 76 and elongation at break of 6.9%. (FIG. 10.) Comparison of PVC film composites comprised of LED formulations E versus F with two different photoinitiators at 5% wt. had no effect on % elongation at break. Similarly, virtually no effect on break elongation was observed utilizing a mercapto based acrylic resin LED2 formulation G versus the high MW aliphatic urethane acrylate in formulation H. Both formulations cured in air gave 6-7% break elongation. (FIG. 10.)

In comparing break elongation of LED coatings cured in nitrogen atmosphere for the DBEW series A, B, C, the expected decrease in elongation is observed. The elongation decreased from 6.6% to 5.2% as the DBEW increased from 59 for A; to 66 for B and to 76 for C. (FIG. 10.)

Dynamic Mechanical Analysis of LED Cured Formulations

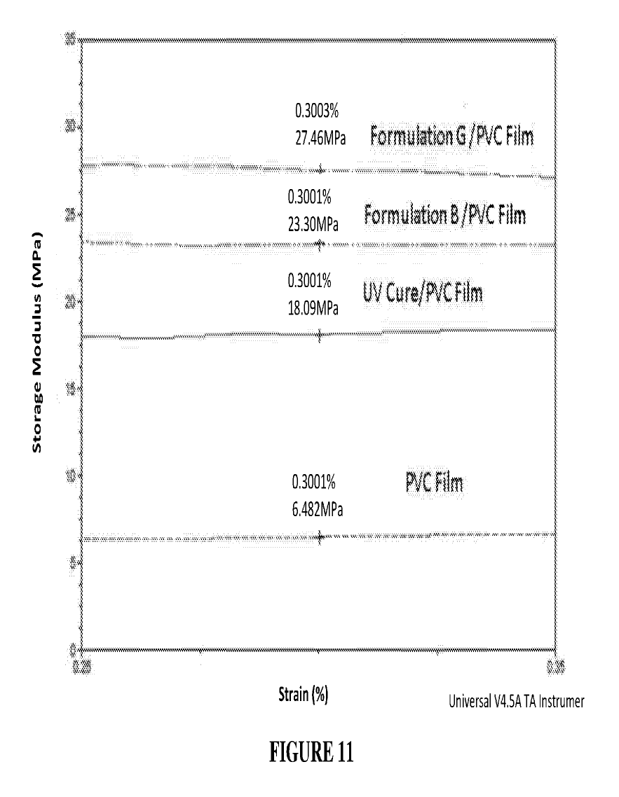

An approach to estimate the degree of cross linking utilized a TA Instruments Model Q-800 Dynamic Mechanical Analyzer (DMA) with tension film clamp. Nominally 0.6 mil coatings were prepared on a 2.6 mil PVC carrier film and cured by UV and LED in air and nitrogen atmosphere. A strain sweep at 100° C. to determine the degree of crosslink density of various LED formulations is illustrated in FIG. 11. As expected, the carrier PVC film displayed the lowest storage moduli at 6.46 MPa in comparison to the UV cured control/PVC laminate with a storage moduli of 18.1 MPa. Increasing the DBEW from 67 to 76 for the LED cured formulations B and G resulted in an increase in storage modulus from 23.3 MPa to 27.5 MPa for the laminate films as a result of higher functionality and crosslinking.

Effect of DBEW on Glass Transition Temperatures for Coatings Cured in Air vs. Nitrogen

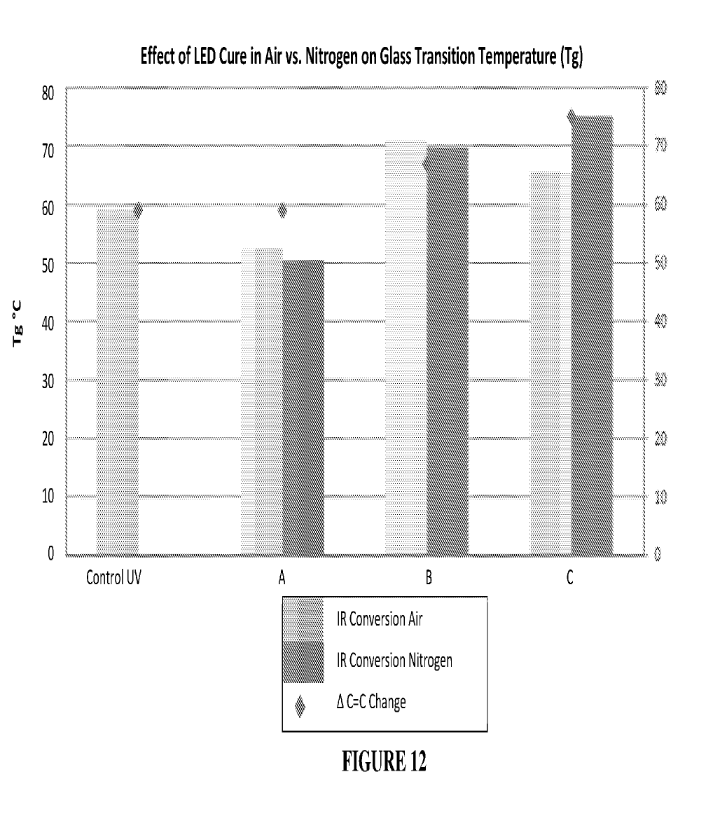

FIGS. 12 and Table 23 summarizes the effect of LED cure in air versus nitrogen atmosphere on glass transition temperature (Tg) for various DBEW formulations.

TABLE 23
Effect to DBEW on Tg (° C.) Inflection
For Coatings Cured in Air vs. Nitrogen.

| | DBEW/ | Air Cure | Nitrogen Cure |
|---|---|---|---|
| Coating | 10000 g | Tg (° F.) | Tg (° F.) |
| Control UV | 59 | 59.1 | |
| A | 59 | 52.4 | 50.4 |
| B | 68 | 70.9 | 69.8 |
| C | 76 | 65.5 | 75.1 |

The expected trend of higher Tg for coatings cured in nitrogen versus air was not observed for all coatings. Formulations A, having a DBEW of 59, shows a slight drops in Tg on going from air to nitrogen cure whereas formulation D, having a DBEW of 76, shows the largest increase in Tg on going form air to nitrogen. For formulation C, DBEW 68, the Tg remained about the same regardless of air vs. nitrogen cure.

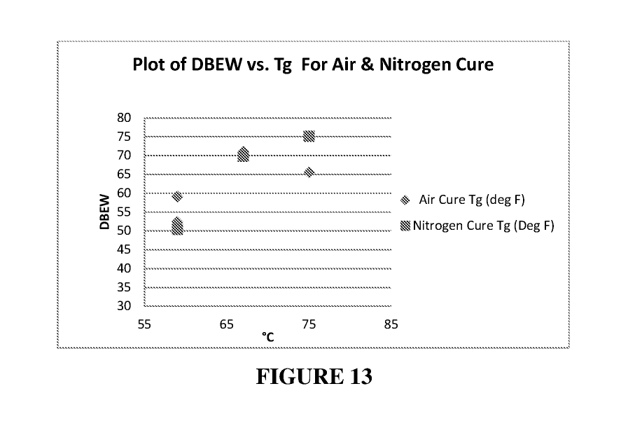

An attempt was made to correlate the glass transition temperature of each coating with the DBEW. The plot of DBEW versus Tg in FIG. 13 shows for the most part the expected trend is observed. As the DBEW increases within the formulation, the glass transition temperature also increases.

LED Topcoat on Wood

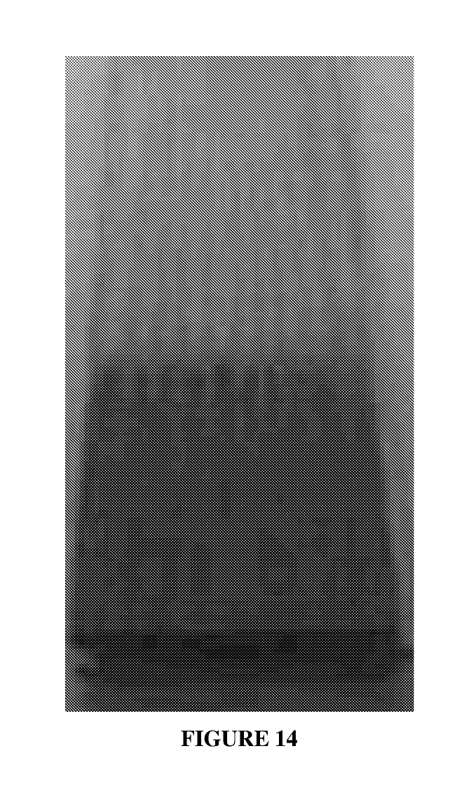

Based on overall properties, double bond conversion in air, and low DBEW, formulation A was applied onto wood substrate that had the coating stack layers applied up to the topcoat layer and cured by UV/LED in air. Gardner scratch results show little to no damage after 30 cycles using the BYK Gardner machine indicating a hard surface was formed. (FIG. 14.) Abrasion testing using the ASTM method D4060 for Taber abrasion showed final wear thru at 1058 cycles versus the UV control at 1105 cycles indicating no significant changes are observed due to the LED/UV topcoat.

Conclusions

UV LED formulations with DBEW ranging from 60-76 containing high viscosity urethane acrylates, mercapto modified resin, and photoinitiators specific for 365 nm and 385 nm LED spectral outputs can be used to give good surface properties for abrasion resistance and stain resistance for flooring applications as long as initial yellowing is taken into consideration. Yellowing was found to be more prevalent using the 3-ketocumarin photoinitiator based on 5% weight used in formulations presented in this paper. Good Scuff, Gardner scratch, and iodine stain resistance can be achieved using a combination of 365 nm and 385 nm LED arrays under an atmosphere of nitrogen. Curing in nitrogen atmosphere resulted in an increase in double bond conversion and improvement in stain performance. The highest reactivity as determined by double bond conversion was achieved using a combination of ITX and TPO photoinitiator followed by using the phosphine oxide based photoinitiator BL723. Mechanical properties of laminate films prepared and cured by 365 nm and 385 nm LED arrays could be related to DBEW for percent elongation at break and storage modulus. The large gap in percent elongation at break for the UV control, 37% versus LED cured coatings 5%-11% is attributed to the significantly higher amount of energy density and peak irradiance used for this LED/UV study.

As those skilled in the art will appreciate, numerous changes and modifications may be made to the embodiments described herein, without departing from the spirit of the disclosure. It is intended that all such variations fall within the scope of the invention.

1. An LED curable coating for a substrate comprising:
a. a coating matrix:
b. an LED cure system; and
c. diamond particles.

2. The coating of claim 1, wherein the LED cure system is selected from a group consisting of photoinitiators, thermal initiators, LED curing resins, and combinations thereof.

3. The coating of claim 1, wherein the photoinitiator is selected from, a group consisting of benzoylphosphine oxides, 2-isopropyl thioxanthone, bis(2,4,6-trimethylbenzoyl) phenylphosphineoxide, 2-methyl-1-[4-(meth.ylthio)phenyl]-2-morphoiinopropanone-1 (, 2-benzyl-2-(dimethylamino)-1-[4-(4-morpholinyl) phenyl]-1-butanone, 2-dimethylamino-2-(4-methyl-benzyl)-1-(4-morpholin-4-yl-phenyl)-butan-1-one, 4-benzoy 1-4′-methyl diphenyl sulphide, 4,4′-bis(diethylamino) benzophenone (, and 4,4′-bis(N,N′-dimethylamino) benzophenone, 4-methyl benzophenone, 2,4,6-trimethyl benzophenone, and dimethoxybenzophenone, and, 1-hydroxyphenyl ketones, benzil dimethyl ketal, and oligo-[2-hydroxy-2-methyl˜1-[4-(lmethylvinyl) phenyl] propanone] (, camphorquinone, 4,4′-bis(diethylamino) benzophenone, 4,4′-bis(N,N′-dimethylamino) benzophenone, bis(2,4,6-trimemylbenzoyl)-phenylphosphineoxide, and any combination thereof.

4. The coating of claim 3, wherein the photoinitiator is selected from a group consisting of bis(2,4, 6-trimemylbenzoyl)-phenylphosphineoxide, 2,4, 6-trimethylbenzoyl diphenylphosphine oxide, Benzophenone, 1-Hydroxycyclohexyl phenyl ketone 2-isopropyl thioxanthone, and any combination thereof.

5. The coating of claim 1, wherein the thermal initiator is selected from a group consisting of a peroxide compound, an azo compound, and a combination thereof.

6. The coating of claim 1, wherein the coating matrix is selected from the group consisting of polyester acrylates, aliphatic polyurethane acrylates, silicone acrylates, and combinations thereof.

7. The coating of claim 6, wherein the diamond particles are encapsulated into a 100% solids coating matrix.

8. The coating of claim 1, further comprising at least one additional abrasion resistant particle.

9. The coating of claim 8, wherein the at least one additional abrasion particle has a Mohs hardness value of at least 6.

10. The coating of claim 1, further comprising a matting, agent.

11. The coating of claim 1, wherein the coating contains about 0.5% to less than 5.5% by weight of diamond particles.

12. The coating of claim 11, wherein the coating contains about 1% to about 5% by weight of diamond particles.

13. The coating of claim 12, wherein the coating contains about 2% to about 4.5% by weight of diamond particles.

14. The coating of claim 1, wherein the coating contains nano-sized diamond particles.

15. The coating of claim 14, wherein the nano-sized diamond particles have an average particle size between about 1.0 to about 900 nanometers.

16. The coating of claim 1, wherein the coating contains micro-sized diamond particles.

17. The coating of claim 16, wherein the micro-sized diamond particles have an average particle size between about 0.2 to about 200 μm.

18. The coating of claim 1, wherein the coating contains a mixture of nano-sized and micro-sized diamond particles.

19. The coating of claim 1, wherein a ratio of the average thickness of a layer of the coating to the average particle size of the diamond particles ranges from about 0.6:1 to about 2:1.

20. The coating of claim 19, wherein the ratio of the average thickness of the layer of the coating to the average particle size of the diamond particles is from about 0.8:1 to about 2:1.

21-34. (canceled)
